(19) United States
(12) Patent Application Publication
(10) Pub. No.: US 2010/0245730 A1
(43) Pub. Date: Sep. 30, 2010

(54) CELLULOSE ACYLATE FILM AND METHOD FOR PRODUCING SAME, RETARDATION FILM, POLARIZER AND IMAGE DISPLAY DEVICE

(75) Inventors: Shigeaki NIMURA, Kanagawa (JP); Kousuke YAMAKI, Kanagawa (JP); Akihiro MATSUFUJI, Kanagawa (JP); Yoji ITO, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/750,801

(22) Filed: Mar. 31, 2010

(30) Foreign Application Priority Data
Mar. 31, 2009 (JP) 2009-085568

(51) Int. Cl. G02F 1/1335; B05D 3/02; C09K 19/00; C08L 1/10

(52) U.S. Cl. 349/96; 427/384; 428/1.1; 106/168.01

(57) ABSTRACT

A method for producing a cellulose acylate film, comprising casting a polymer solution that comprises a plasticizer having a number-average molecular weight of 200-10000 and a cellulose acylate to form a web; stretching the web having a residual solvent amount of 100-300% by mass in one direction at from −30° C. to 30° C.; drying the stretched web to reduce the residual solvent amount from 6-120% by mass to less than 12% by mass while controlling the surface temperature of the web so as not to reach 200° C. or higher; and stretching the resulting film at 60-200° C. in a direction different form the stretching direction of the first stretching.

### CROSS-REFERENCE TO RELATED APPLICATIONS

The present application claims the benefit of priority from Japanese Patent Application No. 2009-085568, filed on Mar. 31, 2009, the contents of which are herein incorporated by reference in their entirety.

### BACKGROUND OF THE INVENTION

1. Field of the Invention

The present invention relates to a method for producing a cellulose acylate film. Precisely, the invention relates to a method for producing a cellulose acylate film having Nz of from 0 to 1.5, and especially to a method for producing the film in which the vaporization and bleeding of the plasticizer from the film being produced is prevented.

2. Description of the Related Art

A polymer film of typically cellulose ester, polyester, polycarbonate, cyclo-olefin polymer, vinyl polymer or polyimide is used in silver halide photographic materials, retardation films, polarizers and image display devices. Films that are more excellent in point of the surface smoothness and the uniformity can be produced from these polymers, and the polymers are therefore widely employed for optical films. Of those, cellulose ester films having suitable moisture permeability can be directly stuck to most popular polarizing films formed of polyvinyl alcohol (PVA)/iodine in on-line operation. Accordingly, cellulose acylate, especially cellulose acetate is widely employed as a protective film for polarizers.

On the other hand, when cellulose acylate film is applied to optical use, for example, in retardation films, supports for retardation films, protective films for polarizers and liquid crystal display devices, the control of their optical anisotropy is an extremely important element in determining the performance (e.g., visibility) of display devices. With the recent demand for broadening the viewing angle of liquid crystal display devices, improvement of retardation compensation in the devices is desired, for which it is desired to suitably control the in-plane retardation Re (this may be simply referred to as Re) and the thickness-direction retardation Rth (this may be simply referred to as Rth) of the retardation film to be disposed between a polarizing film and a liquid crystal cell.

Heretofore, a film having a characteristic of Nz (Nz=Rth/Re+0.5) of from 0 to 1.5 is desired for the optical compensation film for IPS or TN-mode liquid crystal display devices, and a production method for the film has been proposed.

For example, WO2008/114332 proposes production of an optical compensation film having the above optical characteristic by monoaxially stretching a film and heating it at a high temperature of not lower than Tg or Tc.

In JP-A 5-157911, films are laminated and stretched under heat in the machine direction to thereby make the resulting laminate have the above optical characteristic.

However, WO2008/119332 requires the step of stretching and high-temperature crystallization treatment and therefore the production method is complicated and expensive. In addition, as requiring such high-temperature crystallization treatment, the method involves a problem of vaporization and bleeding of the plasticizer in the film.

In JP-A 5-157911, the slow axis direction and the stretching direction are the same, or that is, the film has a slow axis in the machine direction, and therefore the film could not be stuck to a polarizer in a roll-to-roll process. In addition, the method requires a film not used in the final product and is therefore problematic in point of waste increase and cost increase.

Accordingly, a method for producing a film having Nz of from 0 to 1.5 is desired, which is free from the problem of vaporization and bleeding of plasticizer in the film and free from the problem of waste increase and cost increase.

### SUMMARY OF THE INVENTION

In consideration of the above current situation and investigation, the present inventors intended to provide a method for producing a cellulose acylate film having Nz of from 0 to 1.5 and satisfying both additive vaporization resistance and bleeding resistance, which, however, conventional optical compensation films could not attain.

The present inventors have assiduously studied and, as a result, have found that the above-mentioned object of the invention can be attained by the following measures. Specifically, the invention is as follows:

[1] A method for producing a cellulose acylate film, comprising in the following order:

casting a polymer solution that comprises a plasticizer having a number-average molecular weight of from 200 to 10000 and a cellulose acylate to form a web (casting step),

stretching the web having a residual solvent amount of from 100 to 300% by mass in one direction at from −30° C. to 30° C. (first stretching step),

drying the stretched web to reduce the residual solvent amount from 6 to 120% by mass to less than 12% by mass while controlling the surface temperature of the web so as not to reach 200° C. or higher (drying step), and

stretching the resulting film at from 60° C. to 200° C. in a direction different form the stretching direction of the first stretching (second stretching step).

[2] The method for producing a cellulose acylate film according to [1], wherein the residual solvent amount is reduced by the drying from 8 to 100% by mass to from 2 to 10% by mass.
[3] The method for producing a cellulose acylate film according to [1] or [2], wherein the web is stretched in the machine direction of the first stretching.
[4] The method for producing a cellulose acylate film according to any one of [1] to [3], wherein the surface temperature of the web is controlled to be in the range of from 50 to 120° C. during the drying.
[5] The method for producing a cellulose acylate film according to any one of [1] to [4], wherein the degree of acyl substitution of the cellulose acylate film is from 2.7 to 3.0.
[6] The method for producing a cellulose acylate film according to any one of [1] to [5], wherein the acyl group in the cellulose acylate is an acetyl group.
[7] The method for producing a cellulose acylate film according to any one of [1] to [6], wherein the polymer solution comprises a plasticizer having a negative intrinsic birefringence.
[8] The method for producing a cellulose acylate film according to [7], wherein the plasticizer having a negative intrinsic birefringence has a weight-average molecular weight of from 1000 to 10000.
[9] The method for producing a cellulose acylate film according to any one of [1] to [8], wherein the polymer solution comprises a plasticizer having a number-average molecular weight of from 500 to 10000 and having a recurring unit.
[10] The method for producing a cellulose acylate film according to any one of [1] to [9], wherein the polymer solution comprises a polyester-type plasticizer.
[11] The method for producing a cellulose acylate film according to any one of [1] to [10], wherein the polymer solution comprises the plasticizer in an amount of from 2 to 30% by mass of the cellulose acylate therein.

The invention is applicable to the following preferred embodiments:

[12] A cellulose acylate film produced by:

casting a polymer solution that comprises a plasticizer having a number-average molecular weight of from 200 to 10000 and a cellulose acylate to form a web,

stretching the web having a residual solvent amount of from 100 to 300% by mass in one direction at from −30° C. to 30° C.,

drying the stretched web to reduce the residual solvent amount from 6 to 120% by mass to less than 12% by mass while controlling the surface temperature of the web so as not to reach 200° C. or higher, and

stretching the resulting film at from 60° C. to 200° C. in a direction different form the stretching direction of the first stretching.

[13] The cellulose acylate film according to [12], of which the heat of crystallization ΔHc is from 0 to 1.0 J/g.
[14] The cellulose acylate film according to [12] or [13], of which the in-plane retardation (Re) is from 60 nm to 300 nm.
[15] The cellulose acylate' film of according to any one of [12] to [14], of which the direction of the slow axis is perpendicular to the machine direction in the stretching.
[16] The cellulose acylate film according to any one of [12] to [15], of which the thickness-direction retardation (Rth) is from −10 nm to 80 nm.
[17] A retardation film comprising a laminate of an optically anisotropic layer of a liquid crystal composition and the cellulose acylate film of any one of [12] to [16].
[18] A polarizer comprising the cellulose acylate film of any one of [12] to [16].
[19] An image display device comprising the polarizer of [18].
[20] The image display device according to [19] having a liquid crystal cell, of which the display mode is in-plane switching (IPS) or twisted nematic (TN) mode.

The method for producing a cellulose acylate film of the invention does not require high-temperature heat treatment even when the film to be produced is made to satisfy an optical characteristic Nz of from 0 to 1.5, and therefore, the method produces a cellulose acylate film in which the additive evaporation is reduced and the additive bleeding is prevented. The invention also provides a retardation film, a polarizer and a liquid crystal display device comprising the cellulose acylate film and having good optical properties.

### BRIEF DESCRIPTION OF DRAWINGS

FIG. 1 is a schematic cross-sectional view of one embodiment of a polarer to which the cellulose acylate film produced by the method for producing a cellulose acylate film of the invention is applied.

FIG. 2 is a schematic cross-sectional view of one embodiment of a liquid crystal display device to which the cellulose acylate film produced by the method for producing a cellulose acylate film of the invention is applied.

In these figures, 10 denotes retardation film, 11 denotes optically anisotropic layer of liquid crystal composition, 12 denotes cellulose acylate film, 13 denotes polarizing film, 14 denotes protective film, 15 denotes polarizer, 16 denotes liquid crystal cell, and 17 denotes TN-mode liquid crystal display device

### BEST MODE FOR CARRYING OUT THE INVENTION

Description will now be made in detail of the method for producing a cellulose acylate film and the cellulose acylate film produced by the method according to the invention. Although the following description of its structural features may often be made on the basis of typical embodiments of the invention, it is to be understood that the invention is not limited to any such embodiment. It is also to be noted that every numerical range as herein expressed by employing the words “from” and “to”, or simply the word “to”, or the symbol “˜” is supposed to include the lower and upper limits thereof as defined by such words or symbol, unless otherwise noted. In the invention, “mass %” means equal to “weight %”, and “% by mass” means equal to “% by weight”.

In this description, Re(λ) and Rth(λ) each are values of Re and Rth, respectively, at a wavelength of λ nm. Re and Rth referred to herein with no specific definition given thereto are Re(550) and Rth(550), respectively.

### <<Method for Producing a Cellulose Acylate Film>>

The method for producing a cellulose acylate film of the invention (which may be referred to as “the method of the invention” hereinafter) comprises casting a polymer solution that comprises a plasticizer having a number-average molecular weight of from 200 to 10000 and a cellulose acylate to form a web (casting step); stretching the web having a residual solvent amount of from 100 to 300% by mass in one direction at from −30° C. to 30° C. (first stretching step); drying the stretched web to reduce the residual solvent amount from 6 to 120% by mass to less than 12% by mass while controlling the surface temperature of the web so as not to reach 200° C. or higher (drying step); and stretching the resulting film at from 60° C. to 200° C. in a direction different form the stretching direction of the first stretching (second stretching step).

The drying step may be referred to as a crystallization treatment (step). “Web” means a cellulose acylate film before the drying step.

“Reducing the residual solvent amount from the condition thereof of from 6 to 120% by mass to a condition of less than 12% by mass” means that, when the residual solvent amount S (unit: % by mass) at the start of the drying step is from 6 to 12% by mass, the residual solvent amount at the end of the drying step is reduced to less than S % by mass.

According to the cellulose acylate film production method of the invention, a web having a residual solvent amount of from 100 to 300% is stretched in the first stretching step, and therefore, the web is broken little even when the stretching temperature is low as compared with that in dry stretching. In addition, since the draw ratio in stretching may be increased before the crystallization treatment, the degree of crystallinity can be increased even in the crystallization treatment step after the stretching.

In the cellulose acylate film production method of the invention, a web having a residual solvent amount of from 100 to 300% is stretched in the first stretching step, and therefore, the web can be stretched at a high draw ratio. Accordingly, in the production method of the invention, the allowable range of Re of the cellulose acylate film is broad.

Further, the production method of the invention includes the step of drying the web at a mean surface temperature not higher than 200° C., and is characterized by the drying step. Falling within the range, a film having the optical characteristics mentioned below can be obtained in the invention.

Under the above-mentioned condition, the drying temperature is low and therefore the invention is free from the problem of additive bleeding or vaporization to be mentioned below, and is free from the problem of film deterioration.

### <Casting Step>

In the method for producing a cellulose acylate film of the invention, a web is produced by casting a polymer solution comprising a cellulose acylate in the casting step.

### [Cellulose Acylate]

Cellulose acylate is preferably used for the main component polymer of the cellulose acylate film. The “main component polymer” as referred to herein is meant to indicate the polymer itself when the film is formed of a single polymer, and when the film is formed of different polymers, then it indicates the polymer having the highest mass fraction of all the polymers constituting the film.

The cellulose acylate film comprises a cellulose acylate.

Regarding the degree of acyl substitution of the cellulose acylate to be used as the material for the cellulose acylate film, for example, a cellulose acylate having an acetyl group alone may be used, or a composition containing a cellulose acylate having a plurality of different acyl substituents may also be used. Preferably, the cellulose acylate has a total degree of substitution of from 2.7 to 3.0 for making the film have a negative intrinsic birefringence. “Negative intrinsic birefringence” means a property of a polymer film of such that, when stretched, the film has a maximum refractive index in the direction perpendicular to the stretching direction. Preferably in the invention, the film attains the necessary negative intrinsic birefringence when having the above-mentioned degree of acyl substitution and processed through the stretching or crystallization treatment step to be mentioned below.

The cellulose acylate is an ester of cellulose with an acid. The acid for the ester is preferably an organic acid, more preferably a carboxylic acid, further more preferably a fatty acid having from 2 to 22 carbon atoms, most preferably a lower fatty acid having from 2 to 4 carbon atoms.

In the cellulose acylate, all or a part of the hydrogen atoms of the hydroxyl groups existing at the 2-, 3- and 6-positions of the glucose unit constituting the cellulose are substituted with an acyl group. Examples of the acyl group are acetyl, propionyl, butyryl, isobutyryl, pivaloyl, heptanoyl, hexanoyl, octanoyl, decanoyl, dodecanoyl, tridecanoyl, tetradecanoyl, hexadecanoyl, octadecanoyl, cyclohexanecarbonyl, oleoyl, benzoyl, naphthylcarbonyl and cinnamoyl. The acyl group is preferably acetyl, propionyl, butyryl, dodecanoyl, octadecanoyl, pivaloyl, oleoyl, benzoyl, naphthylcarbonyl, cinnamoyl, most preferably acetyl, propionyl, butyryl.

The cellulose ester may be an ester of cellulose with different carboxylic acids. The cellulose acylate may be substituted with different acyl groups.

For the cellulose acylate film produced by the producing method of the invention, expression in Re and humidity dependency of the retardation are controlled by controlling SA and SB. The SA and SB represent a substitution degree of acetyl group (having 2 carbon atoms) which are substituted for hydroxyl group of cellulose of cellulose acylate and a substitution degree of acyl group having 3 or more carbon atoms which are substituted for hydroxyl group of cellulose, respectively. Even more, Tc is also controlled by them and the high vaporization crystallization treatment temperature is thereby controlled. The humidity dependency of the retardation is reversible retardation variation according to the humidity.

In accordance with the necessary optical properties of the film, the cellulose acylate film produced according to the production method of the invention, SA+SB is suitably controlled. Preferably 2.70<SA+SB≦3.00, more preferably 2.88≦SA+SB≦3.00, even more preferably 2.89≦SA+SB≦2.99, still more preferably 2.90≦SA+SB≦2.98, further more preferably 2.92≦SA+SB≦2.97. Increasing SA+SB brings about Re of the film obtained after high vaporization crystallization treatment may be increased, Tc of the film may be lowered and the humidity dependence of the retardation of the film may be improved. When Tc is set lower, the high vaporization crystallization treatment temperature may be set relatively low.

By controlling SB, the humidity dependence of the retardation of the cellulose acylate film produced according to the production method of the invention may be controlled. By increasing SB, the humidity dependence of the retardation of the film may be reduced, and the glass transition temperature and the melting point of the film may lower. In consideration of the balance between the humidity dependence of retardation of the film and the lowering of the glass transition temperature and the melting point thereof, the range of SB is preferably 0<SB≦3.0, more preferably 0<SB≦1.0, even more preferably SB=0. In case where all the hydroxyl groups of cellulose are substituted, the above mentioned degree of substitution is 3.

The Cellulose ester is possible to be synthesized by a known method.

Regarding a method for synthesizing cellulose acylate, its basic principle is described in Wood Chemistry by Nobuhiko Migita et al., pp. 180-190 (Kyoritsu Publishing, 1968). One typical method for synthesizing cellulose acylate is a liquid-phase acylation method with carboxylic acid anhydride-carboxylic acid-sulfuric acid catalyst. Concretely, a starting material for cellulose such as cotton linter or woody pulp is pretreated with a suitable amount of a carboxylic acid such as acetic acid, and then put into a previously-cooled acylation mixture for esterification to synthesize a complete cellulose acylate (in which the overall substitution degree of acyl group in the 2-, 3- and 6-positions is nearly 3.00). The acylation mixture generally includes a carboxylic acid serving as a solvent, a carboxylic acid anhydride serving as an esterifying agent, and sulfuric acid serving as a catalyst. In general, the amount of the carboxylic acid anhydride to be used in the process is stoichiometrically excessive over the overall amount of water existing in the cellulose that reacts with the carboxylic acid anhydride and that in the system.

Next, after the acylation, the excessive carboxylic acid anhydride still remaining in the system is hydrolyzed, for which, water or water-containing acetic acid is added to the system. Then, for partially neutralizing the esterification catalyst, an aqueous solution that contains a neutralizing agent (e.g., carbonate, acetate, hydroxide or oxide of calcium, magnesium, iron, aluminium or zinc) may be added thereto. Then, the resulting complete cellulose acylate is saponified and ripened by keeping it at 20 to 90° C. in the presence of a small amount of an acylation catalyst (generally, sulfuric acid remaining in the system), thereby converting it into a cellulose acylate having a desired substitution degree of acyl group and a desired polymerization degree. At the time when the desired cellulose acylate is obtained, the catalyst still remaining in the system is completely neutralized with the above-mentioned neutralizing agent; or the catalyst therein is not neutralized, and the polymer solution is put into water or diluted acetic acid (or water or diluted acetic acid is put into the polymer solution) to thereby separate the cellulose acylate, and thereafter this is washed and stabilized to obtain the intended product, cellulose acylate.

Preferably, the polymerization degree of the cellulose acylate is 150 to 500 as the viscosity-average polymerization degree thereof, more preferably 200 to 900, even more preferably 220 to 350. The viscosity-average polymerization degree may be measured according to a description of limiting viscosity method by Uda et al. (Kazuo Uda, Hideo Saito; Journal of the Fiber Society of Japan, vol. 18, No. 1, pp. 105-120, 1962). The method for measuring the viscosity-average polymerization degree is described also in JP-A-9-95538.

Cellulose acylate where the amount of low-molecular components is small may have a high mean molecular weight (polymerization degree), but its viscosity may be lower than that of ordinary cellulose acylate. Such cellulose acylate where the amount of low-molecular components is small may be obtained by removing low-molecular components from cellulose acylate synthesized in an ordinary method. The removal of low-molecular components may be attained by washing cellulose acylate with a suitable organic solvent. Cellulose acylate where the amount of low-molecular components is small may be obtained by synthesizing it. In case where cellulose acylate where the amount of low-molecular components is small is synthesized, it is desirable that the amount of the sulfuric acid catalyst in acylation is controlled to be 0.5 to 25 parts by mass relative to 100 parts by mass of cellulose. When the amount of the sulfuric acid catalyst is controlled to fall within the range, then cellulose acylate having a preferable molecular weight distribution (uniform molecular weight distribution) can be synthesized. The polymerization degree and the distribution of the molecular weight of the cellulose acylate can be measured by the gel penetration chromatography (GPC), etc.

The starting material, cotton for cellulose ester and methods for synthesizing it are described also in Hatsumei Kyokai Disclosure Bulletin (No. 2001-1745, issued on Mar. 15, 2001, Hatsumei Kyokai), pp. 7-12.

The cellulose acylate to be used as the starting material in producing the cellulose acylate film may be a powdery or granular one, or may also be pelletized one. The water content of the cellulose acylate to be used as the starting material is preferably at most 1.0% by mass, more preferably at most 0.7% by mass, most preferably at most 0.5% by mass. As the case may be, the water content is preferably at most 0.2% by mass. In case where the water content of the cellulose acylate is not within the preferred range, it is desirable that the cellulose acylate is dried with dry air or by heating and then used in the invention.

In producing the cellulose acylate film, one or more different types of polymers may be used either singly or as combined.

### [Polymer Solution]

The web is produced according to a method of solution casting film formation where the cellulose acylate solution that contains a polymer and optionally various additives is cast into a film in the casting step of the invention. The polymer solution usable in the method of solution casting film formation

### (Solvent)

The main solvent of the polymer solution to be used in producing the cellulose acylate film is preferably an organic solvent that is a good solvent for the cellulose acylate. The organic solvent of the type is preferably one having a boiling point of not higher than 80° C. from the viewpoint of reducing the load in drying. More preferably, the organic solvent has a boiling point of from 10 to 80° C., even more preferably from 20 to 60° C. As the case may be, an organic solvent having a boiling point of from 30 to 45° C. may also be preferably used for the main solvent. In the invention, a solvent system containing a solvent having a small degree of vaporization and capable of being gradually concentrated and having a boiling point of not lower than 95° C. along with a halogenohydrocarbon therein in an amount of from 1 to 15% by mass, preferably from 1 to 10% by mass, more preferably from 1.5 to 8% by mass of all the solvent system may be used, in the initial stage of the drying step. The solvent having a boiling point of not lower than 95° C. is preferably a poor solvent for cellulose acylate. Specific examples of the solvent having a boiling point of not lower than 95° C. include those having a boiling point of not lower than 95° C. of the solvents to be mentioned below as the specific examples of “Organic Solvent to be Combined with the Main Solvent”. Above all, preferred are butanol, pentanol and 1,4-dioxane. More preferably, the solvent for the polymer solution for use in the invention contains an alcohol. In case where the “solvent having a boiling point of not lower than 95° C.” is an alcohol such as butanol, its content may be counted as the alcohol content referred to herein. Using the solvent of the type may increase the mechanical strength of the produced cellulose acylate film at a high vaporization crystallization treatment temperature, and therefore, the film may be prevented from being stretched over the necessity during the high vaporization crystallization treatment and may be thereby prevented from being broken with ease.

The main solvent includes halogenohydrocarbons, esters, ketones, ethers, alcohols and hydrocarbons, which may have a branched structure or a cyclic structure. The main solvent may have two or more functional groups of any of esters, ketones, ethers and alcohols (i.e., —O—, —CO—, —COO—, —OH). Further, the hydrogen atoms in the hydrocarbon part of these esters, ketones, ethers and alcohols may be substituted with a halogen atom (especially, fluorine atom). Regarding the main solvent of the polymer solution to be used in producing the cellulose acylate film produced by the method for producing it of the invention, when the solvent of the solution is a single solvent, then it is the main solvent, but when the solvent is a mixed solvent of different solvents, then the main solvent is the solvent having the highest mass fraction of all the constitutive solvents. The main solvent is preferably a halogenohydrocarbon.

The halogenohydrocarbon is preferably a chlorohydrocarbon, including dichloromethane and chloroform, and dichloromethane is more preferred.

The ester includes, for example, methyl formate, ethyl formate, methyl acetate, ethyl acetate.

The ketone includes, for example, acetone, methyl ethyl ketone.

The ether includes, for example, diethyl ether, methyl tert-butyl ether, diisopropyl ether, dimethoxymethane, 1,3-dioxolan, 4-methyldioxolan, tetrahydrofuran, methyltetrahydrofuran, 1,4-dioxane.

The alcohol includes, for example, methanol, ethanol, 2-propanol.

The hydrocarbon includes, for example, n-pentane, cyclohexane, n-hexane, benzene, toluene.

The organic solvent that may be combined with the main solvent includes halogenohydrocarbons, esters, ketones, ethers, alcohols and hydrocarbons, which may have a branched structure or a cyclic structure. The organic solvent may have two or more functional groups of any of esters, ketones, ethers and alcohols (i.e., —O—, —CO—, —COO—, —OH). Further, the hydrogen atoms in the hydrocarbon part of these esters, ketones, ethers and alcohols may be substituted with a halogen atom (especially, fluorine atom).

Preferable organic solvents that may be combined with the main solvent are the following solvents as well as the above solvents exemplified as the main solvent.

The ester includes, for example, propyl formate, pentyl formate, pentyl acetate.

The ketone includes, for example, diethyl ketone, diisobutyl ketone, cyclopentanone, cyclohexanone, methylcyclohexanone.

The ether includes, for example, dimethoxymethane, anisole, phenetole.

The alcohol includes, for example, 1-propanol, 1-butanol, 2-butanol, tert-butanol, 1-pentanol, 2-methyl-2-butanol, cyclohexanol, 2-fluoroethanol, 2,2,2-trifluoroethanol, 2,2,3,3-tetrafluoro-1-propanol.

The hydrocarbon includes, for example, xylene.

The organic solvent having two or more different types of functional groups includes, for example, 2-ethoxyethyl acetate, 2-methoxyethanol, 2-butoxyethanol, methyl acetoacetate.

The polymer constituting the cellulose acylate film in the invention contains a hydrogen-bonding functional group such as hydroxyl group, ester, ketone and the like, and therefore, the solvent preferably contains an alcohol in an amount of from 5 to 30% by mass, more preferably from 7 to 25% by mass, even more preferably from 10 to 20% by mass of the entire solvent from the viewpoint of reducing the film peeling load from the casting support.

Controlling the alcohol content may make it easy, to control the Re and Rth expression in the cellulose acylate film produced according to the production method of the invention. Concretely, when the alcohol content is increased, then the high vaporization crystallization treatment temperature may be set relatively low, and the ultimate range of Re and Rth may be increased.

In the invention, adding a small amount of water to the polymer solution is also effective for controlling the solution viscosity, for increasing the wet film strength in drying, and for increasing the dope strength in casting on drum; and for example, water may be added to the solution in an amount of from 0.1 to 5% by mass of all the solution, more preferably from 0.1 to 3% by mass, even more preferably from 0.2 to 2% by mass.

Preferred examples of the combination of organic solvents for the polymer solution in the invention may be the same as (1) to (31) in JP-A 2009-262551, to which, however, the invention should not be limited. The numerical data of the ratio are in terms of part by mass.

A non-halogen organic solvent may be used as a main solvent if necessary and a detailed description of a case where the non-halogen organic solvent is the main solvent is given in Hatsumei Kyokai Disclosure Bulletin (No. 2001-1745, issued Mar. 15, 2001, Hatsumei Kyokai).

### (Concentration of the Solution)

The cellulose acylate concentration in the cellulose acylate solution to be prepared herein is preferably from 5% to 40% by mass, more preferably from 10% to 30% by mass, most preferably from 15% to 30% by mass.

The polymer concentration may be so controlled that it could be a predetermined concentration in the stage where polymer is dissolved in solvent. Apart from it, a solution having a low concentration (e.g., from 4% to 14% by mass) is previously prepared, and then it may be concentrated by evaporating the solvent from it. On the other hand, a solution having a high concentration is previously prepared, and it may be diluted. The polymer concentration in the solution may also be reduced by adding additive thereto.

### (Additive)

The polymer solution to be used for producing the cellulose acylate film may contain various liquid or solid additives in accordance with the use of the film, in the steps of producing it. Examples of the additives are plasticizer (its preferred amount is from 2% to 30% by mass of the polymer—the same shall apply hereunder), retardation regulating agent (0.01% to 10% by mass), wavelength dispersion regulating agent (0.1% to 20% by mass), UV absorbent (0.001% to 1% by mass), powdery particles having a mean particle size of from 5 to 3000 nm (0.001% to 1% by mass), fluorine-containing surfactant (0.001% to 1% by mass), release agent (0.0001% to 1% by mass), antioxidant (0.0001% to 1% by mass), IR absorbent (0.001% to 1% by mass).

Preferably, the additive is so controlled that Tc of the cellulose acylate film having a residual solvent amount of at most 1% could change (lower) by from 20° C. to 100° C. before and after the addition of the additive to the film, for promoting the crystallization of the film in the drying step at a lower temperature.

### (1) Plasticizer

The cellulose acylate film is characterized by containing a plasticizer having a number-average molecular weight of from 200 to 10000. The plasticizer for use in the invention is described below. The number-average molecular weight can be measured in a known method.

### (1-1) Plasticizer Having a Negative Birefringence

The polymer solution used in the invention preferably includes a plasticizer having a negative birefringence. A plasticizer having a negative birefringence used in this invention is described in more detail.

The plasticizer having a negative birefringence means a material which, in a cellulose acylate film, shows a negative birefringence relative to a specific direction of the film. In this description, the negative birefringence means that the birefringence index of the film is negative. The matter as to whether a compound has a negative birefringence or not may be known by measuring the birefringence of a film containing the compound and the birefringence of a film not containing the compound and analyzing the difference between them.

The plasticizer having a negative birefringence is not specifically defined so long as it can be used as a plasticizer for cellulose acylate film. Any and every known compound having a negative birefringence can be used in the invention.

The plasticizer having a negative birefringence includes a polymer having a negative birefringence, and needle-like particles having a negative birefringence (including needle-like particles of a polymer having a negative birefringence). The polymer having a negative birefringence and the needle-like particles having a negative birefringence usable in the invention are described below.

The polymer having a negative birefringence is such that, when light has come in the layer of the polymer where the molecules are monoaxially aligned, the refractive index of the light in the alignment direction is smaller than the refractive index of the light in the direction perpendicular to the alignment direction.

The polymer having a negative birefringence includes polymers having a specific cyclic structure, styrenic polymers such as polystyrene, styrene/maleic anhydride copolymer (SMA resin), etc.; polyvinyl pyrrolidone polymers; acrylic polymers such as polymethyl methacrylate, etc.; cellulose ester polymers (except those having a positive birefringence); polyester polymers (except those having a positive birefringence); furanose or pyranose structure-having polymers; acrylonitrile polymers; alkoxysilyl polymers; and their polynary (e.g., binary, ternary) copolymers, etc. One or more different types of these polymers may be used herein either singly or as combined. The copolymers may be either block copolymers or random copolymers.

Of those, especially preferred are polymers having a specific cyclic structure, styrenic polymers, acrylic polymers, alkoxysilyl polymers; and more preferred are polyvinylpyrrolidone, polystyrene, poly-α-methylstyrene, polyhydroxystyrene, polyacrylate, polyacrylic ester, styrene/maleic anhydride copolymer.

### Polymer Having Specific Cyclic Structure in the Side Branch:

As the polymer having a negative birefringence, also preferred are polymers having a cyclic structure in the side branch thereof, which are represented by the following formula (1):

The polymer having a negative birefringence may have only any one cyclic structure of formula (1), and may have any other side branch.

### (Cyclic Structure Represented by Formula (1))

Hereinafter describes a cyclic structure represented by the following formula (1).

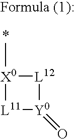

In formula (1), X⁰ represents CR⁰ or a nitrogen atom, and is preferably a nitrogen atom.

R⁰ represents a hydrogen atom or a monovalent substituent. The monovalent substituent is not specifically defined.

Examples of the monovalent substituent include a halogen atom (F, Cl, Br, I), a hydroxyl group, a carboxyl group, a cyano group, an amino group, a nitro group, a sulfo group, a carbamoyl group, a sulfamoyl group, an ureide group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amide group, an aliphatic sulfonamide group, an aliphatic-substituted amino group, an aliphatic-substituted carbamoyl group, an aliphatic-substituted sulfamoyl group, an aliphatic-substituted ureide group and a non-aromatic heterocyclic group.

Number of carbon atoms of the alkyl group is preferably 1-8. A chain alkyl group is preferred to a cyclic alkyl group, and a strait-chain alkyl group is particularly preferred. The alkyl group may further have a substituent (for example, a hydroxyl group, a carboxyl group, an alkoxy group, an alkyl-substituted amino group). Examples of the alkyl group (including the substituted alkyl group) include a methyl group, an ethyl group, a n-butyl group, a n-hexyl group, a 2-hydroxyethyl group, a 4-carboxybutyl group, a 2-methoxyethyl group and 2-diethylaminoethyl group.

Number of carbon atoms of the alkenyl group is preferably 2-8. A chain alkenyl group is preferred to a cyclic alkenyl group, and a straight-chain alkenyl group is particularly preferred. The alkenyl group may further have a substituent. Examples of the alkenyl group include a vinyl group, an aryl group and a 1-hexenyl group.

Number of carbon atoms of the alkynyl group is preferably 2-8. A chain alkynyl group is preferred to a cyclic alkynyl group, and a straight-chain alkynyl group is particularly preferred. The alkynyl group may further have a substituent. Examples of the alkynyl group include an ethynyl group, a 1-butynyl group and a 1-hexynyl group.

Number of carbon atoms of the aliphatic acyl group is preferably 1-10. Examples of the aliphatic acyl group include an acetyl group, a propanoyl group and a butanoyl group.

Number of carbon atoms of the aliphatic acyloxy group is preferably 1-10. Example of the aliphatic acyloxy group includes an acetoxy group.

Number of carbon atoms of the alkoxy group is preferably 1-8. The alkoxy group may further have an substituent (for example, an alkoxy group). Examples of the alkoxy group (including a substituted alkoxy group) include a methoxy group, an ethoxy group, a butoxy group and a methoxyethoxy group.

Number of carbon atoms of the alkoxycarbonyl group is preferably 2-10. Examples of the alkoxycarbonyl group include a methoxycarbonyl group and an ethoxycarbonyl group.

Number of carbon atoms of the alkoxycarbonylamino group is preferably 2-10. Examples of the alkoxycarbonylamino group include a methoxycarbonylamino group and an ethoxycarbonylamino group.

Number of carbon atoms of the alkylthio group is preferably 1-12. Examples of the alkylthio group include a methylthio group, an ethylthio group and an octylthio group.

Number of carbon atoms of the alkylsulfonyl group is preferably 1-8. Examples of the alkylsulfonyl group include a methanesulfonyl group and an ethanesulfonyl group.

Number of carbon atoms of the aliphatic amide group is preferably 1-10. Example of the aliphatic amide group includes an acetamide group.

Number of carbon atoms of the aliphatic sulfonamide group is preferably 1-8. Examples of the aliphatic sulfonamide group include a methane sulfonamido group, a butane sulfonamide group and a n-octane sulfonamido group.

Number of carbon atoms of the aliphatic-substituted amino group is preferably 1-10. Examples of the aliphatic-substituted amino group include a dimethylamino group, a diethylamino group and a 2-carboxyethylamino group.

Number of carbon atoms of the aliphatic-substituted carbamoyl group is preferably 2-10. Examples of the aliphatic-substituted carbamoyl group include a methylcarbamoyl group and a diethylcarbamoyl group.

Number of carbon atoms of the aliphatic-substituted sulfamoyl group is preferably 1-8. Examples of the aliphatic-substituted sulfamoyl group include a methylsulfamoyl group and a diethylsulfamoyl group.

Number of carbon atoms of the aliphatic-substituted ureide group is preferably 2-10. Example of the aliphatic-substituted ureide group includes a methylureide group.

Examples of the non-aromatic heterocyclic group include a piperidino group and a morphorino group.

Y⁰ represents a carbon atom, a nitrogen atom or a sulfur atom, and is preferably a carbon atom or a sulfur atom, more preferably a carbon atom.

L¹¹ represents a single bond or an atomic linking group of which the linking chain consists of one atom. L¹¹ is preferably a single bond. Not specifically defined, the atomic linking group includes a divalent carbon atom-containing linking group, a divalent nitrogen atom-containing linking group, a sulfur atom, an oxygen atom, etc.

L¹² represents a linking group of which the linking chain consists of from 2 to 6 atoms. Preferably, in L¹², the linking chain consists of from 2 to 5 atoms, more preferably from 2 to 4 atoms. Not specifically defined, the linking group may be any divalent one, including, for example, a divalent carbon atom-containing linking group, a divalent nitrogen atom-containing linking group, etc. The linking group may further have a substituent. The substituent includes the monovalent substituent for R⁰.

L¹² is especially preferably a substituted or unsubstituted alkylene group having from 2 to 4 carbon atoms.

The cyclic structure represented by the formula (1) may form an aromatic ring, a hetero ring or an aromatic heterocyclic ring as a whole. The cyclic structure represented by the above formula (1) may have two or more cyclic structures or a condensed-ring, but a single cyclic structure or a monocyclic structure is preferable.

A preferred combination of X⁰, Y⁰, L¹¹ and L¹² is as follows: X⁰ is a nitrogen atom, Y⁰ is a carbon atom, L¹¹ is a single bond, and L¹² is a substituted or unsubstituted alkylene group having from 2 to 4 carbon atoms. More preferred are structures of the following formula (2) or (3).

### (Cyclic Structure Represented by Formula (2) or (3))

First, hereinafter describes a cyclic structure represented by the following formula (2).

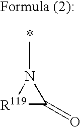

In formula (2), R¹¹⁹ represents a substituted or unsubstituted alkylene group having from 2 to 4 carbon atoms, and is more preferably a substituted or unsubstituted alkylene group having 3 carbon atoms.

The substituent includes, the monovalent substituent for R⁰.

Next, hereinafter describes a cyclic structure represented by the following formula (3).

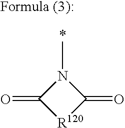

In formula (3), R¹²⁰ represents a substituted or unsubstituted alkylene group having from 1 to 3 carbon atoms. More preferably, R¹²⁰ is a substituted or unsubstituted alkylene group having 2 carbon atoms.

The substituent may be the same as that described for the formula (2). Its preferred range is also the same as in the formula (2).

The cyclic structure represented by the formula (1) is most preferably a pyrrolidone structure.

Specific examples of the cyclic structure represented by the formula (1), (2) or (3) are shown below. However the cyclic structure which can be used in the present invention is not limited to these specific examples below.

Examples of the cyclic structure represented by formulae (1), (2) or (3):

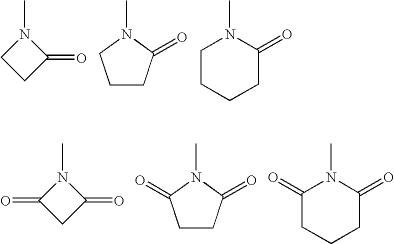

Specific examples of the cyclic structure except for the cyclic structure represented by the formula (1) (2) or (3) are shown below. However the cyclic structure which can be used in the present invention is not limited to these specific examples below.

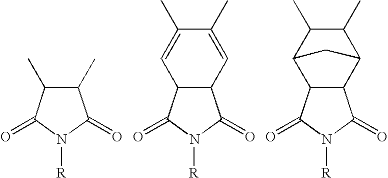

### Styrenic Polymer:

As the polymer having a negative birefringence, styrenic polymers are also preferable.

The styrenic polymers preferably have the structural units derived from aromatic vinylic monomers represented by the following formula (A):

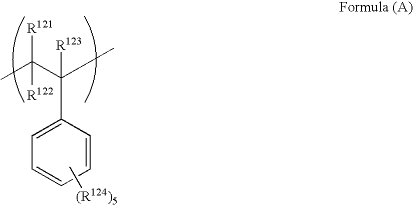

wherein R¹²¹ to R¹²⁴ each independently represent a hydrogen atom, a halogen atom, or a substituted or unsubstituted hydrocarbon group having from 1 to 30 carbon atoms and optionally having a linking group containing an oxygen atom, a sulfur atom, a nitrogen atom or a silicon atom, or a polar group; R¹²⁴'s may be all the same atoms or groups, or may be different atoms or groups, and they may bond to each other to form a carbon ring or a hetero ring (the carbon ring or the hetero ring may have a monocyclic structure or may have a polycyclic structure condensed with any other ring).

Specific examples of the aromatic vinylic monomer include styrene; alkyl-substituted styrenes such as α-methylstyrene, β-methylstyrene, o-methylstyrene, m-methylstyrene, p-methylstyrene; halogen-substituted styrenes such as 4-chlorostyrene, 4-bromostyrene; hydroxystyrenes such as o-hydroxystyrene, m-hydroxystyrene, p-hydroxystyrene, α-methyl-p-hydroxystyrene, 2-methyl-4-hydroxystyrene, 3,4-dihydroxystyrene; vinylbenzyl alcohols; alkoxy-substituted styrenes such as p-methoxystyrene, p-tert-butoxystyrene, m-tert-butoxystyrene; vinylbenzoic acids such as 3-vinylbenzoic acid, 4-vinylbenzoic acid; vinylbenzoates such as methyl 4-vinylbenzoate, ethyl 4-vinylbenzoate; 4-vinylbenzyl acetate; 4-aoetoxystyrene; amidestyrenes such as 2-butylamidostyrene, 4-methylamidestyrene, p-sulfonamidestyrene; aminostyrenes such as 3-aminostyrene, 4-aminostyrene, 2-isopropenylaniline, vinylbenzyldimethylamine; nitrostyrenes such as 3-nitrostyrene, 4-nitrostyrene; cyanostyrenes such as 3-cyanostyrene, 4-cyanostyrene; vinylphenylacetonitrile; arylstyrenes such as phenylstyrene; indenes, etc. However, the invention should not be limited to these examples. Two or more different such monomers may be copolymerized to give copolymers for use herein. Of those, preferred are styrene and α-methylstyrene, from the viewpoint that they are easily available industrially and are inexpensive.

### Acrylic Polymer:

As the polymer having a negative birefringence, acrylic polymers are also preferable.

The acrylic polymers preferably have the structural units derived from acrylate monomers represented by the following formula (B):

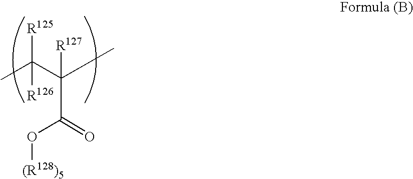

wherein R¹²⁵ to R¹²⁸ each independently represent a hydrogen atom, a halogen atom, or a substituted or unsubstituted hydrocarbon group having from 1 to 30 carbon atoms optionally having a linking group containing an oxygen atom, a sulfur atom, a nitrogen atom or a silicon atom, or a polar group.

Examples of the acrylate monomers include, for example, methyl acrylate, ethyl acrylate, (i-, n-)propyl acrylate, (n-, i-, s-, tert-) butyl acrylate, (n-, s-) pentyl acrylate, (n-, i-) hexyl acrylate, (n-, 1-) heptyl acrylate, (n-, i-) octyl acrylate, (n-, i-) nonyl acrylate, (n-, i-)myristyl acrylate, (2-ethylhexyl) acrylate, (ε-caprolactone) acrylate, (2-hydroxyethyl) acrylate, (2-hydroxypropyl) acrylate, (3-hydroxypropyl acrylate, (4-hydroxybutyl) acrylate, (2-hydroxybutyl) acrylate, (2-methoxyethyl) acrylate, (2-ethoxyethyl) acrylate, phenyl acrylate, phenyl methacrylate, (2 or 4-chlorophenyl) acrylate, (2 or 4-chlorophenyl) methacrylate, (2 or 3 or 4-ethoxycarbonylphenyl) acrylate, (2 or 3 or 4-ethoxycarbonylphenyl) methacrylate, (o or m or p-tolyl) acrylate, (o or m or p-tolyl) methacrylate, benzyl acrylate, benzyl methacrylate, phenethyl acrylate, phenethyl methacrylate, (2-naphthyl) acrylate, cyclohexyl acrylate, cyclohexyl methacrylate, (4-methylcyclohexyl) acrylate, (4-methylcyclohexyl) methacrylate, (4-ethylcyclohexyl) acrylate, (4-ethylcyclohexyl) methacrylate, and methacrylates corresponding to the above-mentioned acrylates. However, the invention should not be limited to these examples. Two or more such monomers may be copolymerized into copolymers for use herein. Of those, preferred are methyl acrylate, ethyl acrylate, (i-, n-)propyl acrylate, (n-, s-, tert-)butyl acrylate, (n-, s-) pentyl acrylate, (n-, i-)hexyl acrylate, and methacrylates corresponding to these acrylates, from the viewpoint that they are easily available industrially and are inexpensive.

Not overstepping the scope and the sprit of the invention, the polymer having a negative birefringence in the invention may be a copolymer. In case where the polymer having a negative birefringence is a copolymer, it may be a block copolymer or a random copolymer. It may also be a grafted copolymer.

The polymer having a cyclic structure represented by formula (1) or etc in the side branch may be a homopolymer of a monomer having a cyclic structure represented by formula (1) or etc in the side branch, a copolymer of at least two monomers having a cyclic structure represented by formula (1) or etc in the side branch, or a copolymer of a monomer having a cyclic structure represented by (1) or etc in the branch and any other monomer.

Said other monomers are not specifically defined. For example, they include acrylic acid, methacrylic acid, alkyl acrylate (e.g., methyl acrylate, ethyl acrylate), alkyl methacrylate (e.g., methyl methacrylate, ethyl methacrylate), aminoalkyl acrylate (e.g., diethylaminoethyl acrylate), aminoalkyl methacrylate, monoester of acrylic acid and glycol, monoester of methacrylic acid and glycol (e.g., hydroxyethyl methacrylate), alkali metal salt of acrylic acid, alkali metal salt of methacrylic acid, ammonium salt of acrylic acid, ammonium salt of methacrylic acid, quaternary ammonium derivative of aminoalkyl acrylate, quaternary ammonium derivative of aminoalkyl methacrylate, quaternary ammonium compound of diethylaminoethyl acrylate and methyl sulfate, vinyl methyl ether, vinyl ethyl ether, alkali metal salt of vinylsulfonic acid, ammonium salt of vinylsulfonic acid, styrenesulfonic acid, styrenesulfonic acid salt, allylsulfonic acid, allylsulfonic acid salt, methallylsulfonic acid, methallylsulfonic acid salt, vinyl acetate, vinyl stearate, N-vinylimidazole, N-vinylacetamide, N-vinylformamide, N-vinylcaprolactam, N-vinylcarbazole, acrylamide, methacrylamide, N-alkylacrylamide, N-methylolacrylamide, N,N-methylenebisacrylamide, glycol diacrylate, glycol dimethacrylate, divinylbenzene, glycol diallyl ether, etc. Of those, preferred are vinyl acetate, acrylic acid, methacrylic acid, and methyl acrylate, more preferred are vinyl acetate and methyl acrylate, particularly preferred is vinyl acetate.

In case where the degree of acyl substitution in the cellulose acylate resin is high, the hydrophobicity of the cellulose acylate resin is high; and therefore, it is desirable that the polymer is a copolymer of a monomer having a cyclic structure represented by formula (1) or etc in the side branch and any other monomer so that the copolymer may have an increased degree of hydrophobicity and the compatibility, of the copolymer with the resin is thereby enhanced. On the contrary, when the degree of acyl substitution in the cellulose acylate resin is low, the hydrophobicity of the cellulose acylate resin is low; and therefore, it is desirable that the polymer is a copolymer of a monomer having a cyclic structure represented by formula (1) or etc in the side branch and any other monomer so that the copolymer may have a decreased degree of hydrophobicity and the compatibility of the copolymer with the resin is thereby enhanced. For example, when a vinylpyrrolidone homopolymer is used as the copolymer having a cyclic structure represented by formula (1) or etc in the side branch, the vinylpyrrolidone homopolymer is hydrophilic and therefore its compatibilitywith a cellulose acylate resin having a high degree of acyl substitution. Accordingly, for example, a copolymer of polyvinylpyrrolidone and polyvinyl acetate is formed and its copolymerization ratio is suitably controlled, whereby the hydrophilicity/hydrophobicity of the thus-constructed copolymer may be suitably controlled in accordance with the degree of acyl substitution of the cellulose acylate resin. Thus controlling the compatibility of the two in the manner as above is preferred as capable of preventing the cellulose acylate film to be formed from being bled or whitened.

In the copolymer of a monomer having a cyclic structure represented by formula (1) or etc in the side branch and another monomer, the copolymerization ratio of the monomer having a cyclic structure represented by formula (1) or etc in the side branch to the other monomer is preferably from 3/7 to 9/1, more preferably from 3/7 to 7/3, even more preferably from 5/5 to 7/3.

In the case where the polymer having a negative birefringence is a copolymer, it preferably has at least one selected from the structural units derived from the aromatic vinyl monomers represented by the formula (A) and the structural units derived from the acrylate monomers represented by the formula (B).

### Needle-Like Particles:

The needle-like particles having a negative birefringence include at least one type of needle-like particles having a negative birefringence in the stretching direction. Not specifically defined, the needle-like particles having a negative birefringence in the stretching direction include needle-like inorganic particles and needle-like polymer particles. The needle-like particles have a negative birefringence in the alignment direction.

As the needle-like polymer particles, preferred are polystyrene or acrylic resin rod-shaped crystals. For example, they may be short fiber-like needle-like crystals produced by finely cutting polystyrene resin or acrylic resin ultrafine fibers. Preferably, these fibers are stretched during their production as capable of readily expressing birefringence. Also preferably, these resins are crosslinked.

The birefringence of the above-mentioned birefringent needle-like crystals is defined as follows: The refractive index of the birefringent particles to the light polarized in the major diameter direction of the particles is represented by npr, and the mean refractive index thereof to the light polarized in the direction perpendicular to the major diameter direction is by nvt. The birefringence Δn of the birefringent particles is defined by Δn=npr−nvt.

Accordingly, when the refractive index of the birefringent particles in the major diameter direction thereof is larger than the mean refractive index in the direction perpendicular to the major diameter direction thereof, then the particles have a positive birefringence, and the birefringent particles contrary to them have a negative birefringence.

The amount of the compound having a negative birefringence to be added is preferably from 0.5 to 40 parts by mass relative to 100 parts by mass of the cellulose acylate resin, more preferably from 0.5 to 30 parts by mass, even more preferably from 1 to 20 parts by mass.

In case where the compound having a negative birefringence is a polymer having a negative birefringence, the weight-average molecular weight of the polymer having a negative birefringence is preferably from 500 to 10,000, more preferably from 500 to 6,000, particularly preferably from 500 to 2,000.

Having a molecular weight of at least 500, the evaporative of the polymer having a negative birefringence is low and it is preferable; while having a molecular weight of at most 10,000, the miscibility of the polymer having a negative birefringence with cellulose acylate resin is be good which makes productivity of the cellulose acylate film good; and both are favorable. The weight average molecular weight can be determined by a known method.

### (1-2) Polymer Plasticizer

Preferably, the cellulose acylate film contains a plasticizer having a number-average molecular weight of from 500 to 10000 and having a recurring unit (hereinafter this may be referred to as “polymer plasticizer”). In solution casting, the plasticizer is an indispensable material for accelerating the vaporization speed of the solvent and for reducing the residual solvent amount. In the invention, the crystallization treatment can be attained at a low temperature, and therefore the invention has solved the problem of plasticizer bleeding out of the film that is often problematic when the plasticizer has a high molecular weight.

In melt casting for polymer film formation, plasticizer is also a useful material for preventing film discoloration or strength reduction. In particular, adding the polymer plasticizer to the cellulose acylate film is effective from the viewpoint of modifying the film, for example, for enhancing the mechanical properties of the film, making the film flexible, making the film resistant to water absorption and reducing the water vapor permeability of the film.

In addition, the polymer plasticizer is also effective for reducing the bright point defects in forming a liquid crystal layer on the cellulose acylate film by coating.

The polymer plasticizer in the invention is characterized by having a repetitive unit in the compound. The polymer plasticizer for use in the invention has a number-average molecular weight of from 500 to 10,000, preferably from 500 to 6,000, more preferably from 500 to 2,000. However, the polymer plasticizer in the invention is not limited to the compound having such a repetitive unit segment, but may be a mixture with a compound not having a repetitive unit.

The polymer plasticizer in the invention may be liquid or solid at the environment temperature or humidity at which it is used (in general, at room temperature, or that is, at 25° C. and relative humidity of 60%). Preferably, its color is as light as possible, and more preferably, it is colorless. Preferably, it is thermally stable at high temperatures, and more preferably its decomposition starting temperature is not lower than 150° C., more preferably not lower than 200° C., even more preferably not lower than 250° C. The amount of addition of the polymer plasticizer is not limited so long as optical and physical properties are not deteriorated. The amount can be determined within the range not overstepping the purpose of the invention. Preferably, the amount of addition of the polymer plasticizer to 100 parts by weight of the cellulose acylate used in the invention is from 1 to 50 parts by weight, more preferably 2 to 40 parts by weight, even more preferably 5 to 30 parts by weight.

The polymer plasticizer for use in the invention is described in detail hereinafter with reference to its specific examples, to which, however, the polymer plasticizer for use in the invention should not be limited.

Not specifically defined, the polymer plasticizer for use in the cellulose acylate film is preferably at least one plasticizer having a number-average molecular weight of at least 500 and selected from polyester plasticizers, polyether plasticizers, polyurethane plasticizers, polyester polyurethane plasticizers, polyester polyether plasticizers, polyether polyurethane plasticizers, polyamide plasticizers, polysulfone plasticizers, polysulfone amide plasticizers, and other polymer plasticizers mentioned below.

More preferably, at least one of them is any of polyester plasticizers, polyether plasticizers, polyurethane plasticizers, polyester polyurethane plasticizers, polyester polyether plasticizers, polyether polyurethane plasticizers, polyamide plasticizers, polysulfone plasticizers and polysulfone amide plasticizers, polyacrylate ester plasticizers, polymethacrylate ester plasticizers, more particularly preferably any of polyester plasticizers, polyester polyether plasticizers, polyester polyurethane plasticizers, polyacrylate ester plasticizers and polymethacrylate ester plasticizers, even more particularly preferably any of polyester plasticizers, polyester polyurethane plasticizers and polyester, polyether plasticizers, furthermore particularly preferably a polyester plasticizers in view of compatibility and optical property of cellulose acylate. Preferred polymer plasticizers for use in the invention are described below according to their kinds.

### Polyester Plasticizer:

The polyester plasticizer for use in the invention is described. Not specifically defined, the polyester plasticizer preferred for use in the invention is one produced through reaction of a dicarboxylic acid and a glycol, and both ends of the reaction product may be as such, or may be blocked by further reaction with a monocarboxylic acid or a monoalcohol. The terminal blocking may be effected for the reason that the absence of a free carboxylic acid in the plasticizer is effective for the storability of the plasticizer. The dicarboxylic acid for the polyester plasticizer for use in the invention is preferably an aliphatic dicarboxylic having from 4 to 12 carbon atoms, or an aromatic dicarboxylic acid having from 8 to 12 carbon atoms.

The alkylenedicarboxylic acid component having from 4 to 12 carbon atoms preferred for the polyester plasticizer in the invention includes, for example, succinic acid, maleic acid, fumaric acid, glutaric acid, adipic acid, azelaic acid, sebacic acid, dodecanedicarboxylic acid, 1,4-cyclohexanedicarboxylic acid. The arylenedicarboxylic acid component having from 8 to 12 carbon atoms includes phthalic acid, terephthalic acid, 1,5-naphthalenedicarboxylic acid, 1,4-naphthalenedicarboxylic acid. In those, phthalic acid which bonds to the glycol at ortho position is preferable for increasing the film Re expression. One or more of these may be used either singly or as combined. The glycol for the polyester plasticizer is described. It includes an aliphatic or alicyclic glycol having from 2 to 12 carbon atoms, and an aromatic glycol having from 6 to 12 carbon atoms.

The aliphatic glycol and the alicyclic glycol having from 2 to 12 carbon atoms include ethylene glycol, 1,2-propylene glycol, 1,3-propylene glycol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol. One or more of these glycols may be used either singly or as combined.

Preferably, the polyester plasticizer in the invention is protected with a monoalcohol residue or a monocarboxylic acid residue in order that both ends of the polyester plasticizer are not a carboxylic acid. In this case, the monoalcohol residue described in JP-A 2009-262551 is preferably usable.

In blocking with a monocarboxylic acid residue, the monocarboxylic acid for use as the monocarboxylic acid residue is preferably a substituted or unsubstituted monocarboxylic acid having from 1 to 30 carbon atoms. It may be an aliphatic monocarboxylic acid or, an aromatic monocarboxylic acid. Preferred aliphatic monocarboxylic acids are described. They include acetic acid, propionic acid, butanoic acid, caprylic acid, caproic acid, decanoic acid, dodecanoic acid, stearic acid, oleic acid. Preferred aromatic monocarboxylic acids are described in JP-A 2009-262551. One or more of these may be used either singly or as combined.

The specific examples of the polyester plasticizer and method for synthesizing the polyesters and commercial products thereof are, for example, described in JP-A 2009-262551.

### Polyester Polyether Plasticizer:

Next described are polyester polyether plasticizers for use in the invention. The polyester polyether plasticizers for use in the invention are condensed polymers of a dicarboxylic acid and a polyether diol. The dicarboxylic acid may be the aliphatic dicarboxylic acid having from 4 to 12 carbon atoms or the aromatic dicarboxylic acid having from 8 to 12 carbon atoms described in the above for polyester plasticizers.

The polyether having an aliphatic glycol with from 2 to carbon atoms includes polyethylene ether glycol, polypropylene ether glycol, polytetramethylene ether glycol, and their combinations. Commercial polyether glycols that are typically usable herein are Carbowax resin, Pluornics resin and Niax resin. In producing the polyester polyether plasticizers, for use in the invention, employable is any polymerization method well known to those skilled in the art.

Polyester polyether plasticizers described in U.S. Pat. No. 4,349,469 are usable herein. Basically, they are polyester polyether plasticizers produced from, for example, 1,4-cyclohexanedicarboxylic acid as a dicarboxylic acid component and 1,4-cyclohexanedimethanol and polytetramethylene ether glycol as a polyether component. Other useful polyester polyether plasticizers are commercial resins such as DuPont's Hytrel copolyesters, GAF's Galflex copolymers. For these, the materials described in JP-A 5-197073 are employable. Adeka's commercial products, Adekacizer RS series are usable herein. ICI Chemicals (Wilmington, Del.) commercially sell polyester ether plasticizers of alkyl-functionalized polyalkylene oxides as trade name of Pycal series (e.g., Pycal 94, polyethylene oxide phenyl ester).

### Polyester Polyurethane Plasticizer:

Polyester polyurethane plasticizers for use in the invention are described. The plasticizers may be produced through condensation of a polyester with an isocyanate compound. The polyester may be the unblocked polyester described in the above for polyester plasticizers; and those described for polyester plasticizers are also preferably used herein. The diisocyanate component to constitute the polyurethane structure includes OCN(CH₂)ₚNCO (p=2 to 8) polymethylene isocyanates such as typically ethylene diisocyanate, trimethylene diisocyanate, tetramethylene diisocyanate, hexamethylene diisocyanate; and aromatic diisocyanates such as p-phenylene diisocyanate, tolylene diisocyanate, p,p′-diphenylmethane diisocyanate, 1,5-naphthylene diisocyanate; and further m-xylylene diisocyanate, to which, however, the diisocyanate compound should not be limited. Of those, especially preferred are tolylene diisocyanate, m-xylylene diisocyanate, tetramethylene diisocyanate.

The polyester polyurethane plasticizers for use in the invention may be readily produced in an ordinary method in which starting compounds, a polyester diol and a diisocyanate are mixed and stirred under heat. For these, the materials described in JP-A 5-197073, 2001-122979, 2004-175971, 2004-175972 may be used.

### Saccharide:

In addition, in the invention, a compound having a furanose structure or a pyranose structure may also be used. Specifically, the compound is a sugar ester compound having at least one furanose structure or pyranose structure, or having from 1 to 12 furanose structures or pyranose structures bonding to each other, in which all or a part of OH groups are esterified.

Preferred examples of the compound are mentioned below, to which, however, the invention should not be limited.

There are mentioned glucose, galactose, mannose, fructose, xylose, arabinose, lactose, sucrose, cellobiose, cellotriose, maltotriose, raffinose, etc. Especially preferred are those having both a furanose structure and a pyranose structure. One example is sucrose.

The monocarboxylic acid for use for the “sugar ester compound having at least one furanose structure or pyranose structure, or having from 1 to 12 furanose structures or pyranose structures bonding to each other, in which all or a part of OH groups are esterified” is not specifically defined, and may be any known aliphatic monocarboxylic acid, alicyclic monocarboxylic acid, aromatic monocarboxylic acid, etc. One or more carboxylic acids may be used either singly or as combined.

Preferred examples of the aliphatic monocarboxylic acid include saturated fatty acids such as acetic acid, propionic acid, butyric acid, isobutyric acid, valeric acid, caproic acid, enanthic acid, caprylic acid, pelargonic acid, capric acid, 2-ethyl-hexanecarboxylic acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid, lacceric acid, etc.; and unsaturated fatty acids such as undecylenic acid, oleic acid, sorbic acid, linolic acid, linoleic acid, arachidonic acid, octenoic acid, etc.

Preferred examples of the alicyclic monocarboxylic acid include cyclopentanecarboxylic acid, cyclohexanecarboxylic acid, cyclooctanecarboxylic acid, and their derivatives.

Preferred examples of the aromatic monocarboxylic acid include benzoic acid and other aromatic monocarboxylic acids prepared by introducing from 1 to 5 alkyl groups or alkoxy groups into the benzene ring of benzoic acid, such as toluic acid, etc.; cinnamic acid; aromatic monocarboxylic acids having 2 or more benzene rings, such as benzilic acid, biphenylcarboxylic acid, naphthalenecarboxylic acid, tetralincarboxylic acid, etc.; and their derivatives. Especially preferred is benzoic acid.

### Other Polymer Plasticizers:

In the invention, not only the above-mentioned polyester plasticizers, polyester polyether plasticizers, polyester polyurethane plasticizers and saccharides but also any other polymer plasticizers are usable. The other polymer plasticizers are aliphatic hydrocarbon polymers; alicyclic hydrocarbon polymers; acrylic polymers such as polyacrylates and polymethacrylates (in which the ester group is, for example, a methyl group, an ethyl group, a propyl group, a butyl group, an isobutyl group, a pentyl group, a hexyl group, a cyclohexyl group, an octyl group, a 2-ethylhexyl group, a nonyl group, an isononyl group, a tert-nonyl group, a dodecyl group, a tridecyl group, a stearyl group, an oleyl group, a benzyl group, a phenyl group); vinylic polymers such as polyvinyl isobutyl ether, poly-N-vinylpyrrolidone; styrenic polymers such as polystyrene, poly-4-hydroxystyrene; polyethers such as polyethylene oxide, polypropylene oxide; and polyamides, polyurethanes, polyureas, phenol/formaldehyde condensates, urea/formaldehyde condensates, polyvinyl acetate, etc.

These polymer plasticizers may be homopolymers comprising one type of a repetitive unit, or may be copolymers comprising plural types of repetitive structures. Two or more of the above polymers may be used, as combined. These polymer plasticizers may be used either alone or as combined; and in any case, they may exhibit the same effect. Of those, preferred are polyacrylates, polymethacrylates and their copolymers with any other vinyl monomer. Especially preferred are polymer plasticizers basically comprising acrylic polymers such as polyacrylates and polymethacrylates (in which the ester group is a methyl group, an ethyl group, a propyl group, a butyl group, a hexyl group, a cyclohexyl group, a 2-ethylhexyl group, an isononyl group, an oleyl group).

Preferred specific examples of polymer plasticizers are described below; however, the polymer plasticizers usable in the invention should not be limited to these.

PP-1: Condensate of ethanediol/succinic acid (1/1 by mol) (number-average molecular weight 2500)
PP-2: Condensate of 1,3-propanediol/glutaric acid (1/1 by mol) (number-average molecular weight 1500)
PP-3: Condensate of 1,3-propanediol/adipic acid (1/1 by mol) (number-average molecular weight 1300)
PP-4: Condensate of 1,3-propanediol/ethylene glycol/adipic acid (1/1/2 by mol) (number-average molecular weight 1500)
PP-5: Condensate of 2-methyl-1,3-propanediol/adipic acid (1/1 by mol) (number-average molecular weight 1200)
PP-6: Condensate of 1,4-butanediol/adipic acid (1/1 by mol) (number-average molecular weight 1500)
PP-7: Condensate of 1,4-cyclohexanediol/succinic acid (1/1 by mol) (number-average molecular weight 800)
PP-8: Condensate of 1,3-propanediol/succinic acid (1/1 by mol) blocked with butyl ester at both ends (number-average molecular weight 1300)
PP-9: Condensate of 1,3-propanediol/glutaric acid (1/1 by mol) blocked with cyclohexyl ester at both ends (number-average molecular weight 1500)
PP-10: Condensate of ethanediol/succinic acid (1/1 by mol) blocked with 2-ethylhexyl ester at both ends (number-average molecular weight 3000)
PP-11: Condensate of 1,3-propanediol/ethylene glycol/adipic acid (1/1/2 by mol) blocked with isononyl ester at both ends (number-average molecular weight 1500)
PP-12: Condensate of 2-methyl-1,3-propanediol/adipic acid (1/1 by mol) blocked with propyl ester at both ends (number-average molecular weight 1300)
PP-13: Condensate of 2-methyl-1,3-propanediol/adipic acid (1/1 by mol) blocked with 2-ethylhexyl ester at both ends (number-average molecular weight 1300)
PP-14: Condensate of 2-methyl-1,3-propanediol/adipic acid (1/1 by mol) blocked with isononyl ester at both ends (number-average molecular weight 1300)
PP-15: Condensate of 1,4-butanediol/adipic acid (1/1 by mol) blocked with butyl ester at both ends (number-average molecular weight 1800)
PP-16: Condensate of ethanediol/terephthalic acid (1/1 by mol) (number-average molecular weight 2000)
PP-17: Condensate of 1,3-propanediol/1,5-naphthalenedicarboxylic acid (1/1 by mol) (number-average molecular weight 1500)
PP-18: Condensate of 2-methyl-1,3-propanediol/isophthalic acid (1/1 by mol) (number-average molecular weight 1200)
PP-19: Condensate of 1,3-propanediol/terephthalic acid (1/1 by mol) blocked with benzyl ester at both ends (number-average molecular weight 1500)
PP-20: Condensate of 1,3-propanediol/1,5-naphthalenedicarboxylic acid (1/1 by mol) blocked with propyl ester at both ends (number-average molecular weight 1500)
PP-21: Condensate of 2-methyl-1,3-propanediol/isophthalic acid (1/1 by mol) blocked with butyl ester at both ends (number-average molecular weight 1200)
PP-22: Condensate of poly(mean degree of polymerization 5)propylene ether glycol/succinic acid (1/1 by mol) (number-average molecular weight 1800)
PP-23: Condensate of poly(mean degree of polymerization 3)ethylene ether glycol/glutaric acid (1/1 by mol) (number-average molecular weight 1600)
PP-24: Condensate of poly(mean degree of polymerization 4)propylene ether glycol/adipic acid (1/1 by mol) (number-average molecular weight 2200)
PP-25: Condensate of poly(mean degree of polymerization 4)propylene ether glycol/phthalic acid (1/1 by mol) (number-average molecular weight 1500)
PP-26: Condensate of poly(mean degree of polymerization 5)propylene ether glycol/succinic acid (1/1 by mol) blocked with butyl ester at both ends (number-average molecular weight 1900)
PP-27: Condensate of poly(mean degree of polymerization 3) ethylene ether glycol/glutaric acid (1/1 by mol) blocked with 2-ethylhexyl ester at both ends (number-average molecular weight 1700)
PP-28: Condensate of poly(mean degree of polymerization 4)propylene ether glycol/adipic acid (1/1 by mol) blocked with tert-nonyl ester at both ends (number-average molecular weight 1300)
PP-29: Condensate of poly(mean degree of polymerization 4)propylene ether glycol/phthalic acid (1/1 by mol) blocked with propyl ester at both ends (number-average molecular weight 1600)
PP-29′: Condensate of ethanediol/adipic acid (1/1 by mol) (number-average molecular weight 1000)
PP-30: Polyester urethane compound produced through condensation of 1,3-propanediol/succinic acid (1/1 by mol) condensate (number-average molecular weight 1500) with trimethylene diisocyanate (1 mol)
PP-31: Polyester urethane compound produced through condensation of 1,3-propanediol/glutaric acid (1/1 by mol) condensate (number-average molecular weight 1200) with tetramethylene diisocyanate (1 mol)
PP-32: Polyester urethane compound produced through condensation of 1,3-propanediol/adipic acid (1/1 by mol) condensate (number-average molecular weight 1000) with p-phenylene diisocyanate (1 mol)
PP-33: Polyester urethane compound produced through condensation of 1,3-propanediol/ethylene glycol/adipic acid (1/1/2 by mol) condensate (number-average molecular weight 1500) with tolylene diisocyanate (1 mol)
PP-34: Polyester urethane compound produced through condensation of 2-methyl-1,3-propanediol/adipic acid (1/1 by mol) condensate (number-average molecular weight 1200) with m-xylylene diisocyanate (1 mol)
PP-35: Polyester urethane compound produced through condensation of 1,4-butanediol/adipic acid (1/1 by mol) condensate (number-average molecular weight 1500) with tetramethylene diisocyanate (1 mol)
PP-36: Polyisopropyl acrylate (number-average molecular weight 1300)
PP-37: Polybutyl acrylate (number-average molecular weight 1300)
PP-38: Polyisopropyl methacrylate (number-average molecular weight 1200)
PP-39: Poly(methyl methacrylate/butyl methacrylate) (8/2 by mol) (number-average molecular weight 1600)
PP-40: Poly(methyl methacrylate/2-ethylhexyl methacrylate) (9/1 by mol) (number-average molecular weight 1600)
PP-41: Poly(vinyl acetate) (number-average molecular weight 2400)

Preferably, the cellulose acylate film contains the plasticizer in an amount of from 2 to 30% by mass, more preferably from 5 to 25% by mass, even more preferably from 5 to 20% by mass relative to the polymer therein, from the viewpoint of the optical properties of the film and from the viewpoint of making the film non-brittle.

### (2) Retardation Regulating Agent

The retardation regulating agent are organic compounds having a molecular weight of at most 50,000, preferably those having both a hydrophilic part and a hydrophobic part. These compounds are aligned between the polymer chains, therefore changing the retardation of the cellulose acylate film. Combined with cellulose acylate that is especially preferably used in the invention, these compounds may improve the hydrophobicity of the film and may reduce the moisture-dependent change of the retardation thereof. When combined with the above-mentioned UV absorbent or the above-mentioned IR absorbent, they may effectively control the wavelength dependence of the retardation of the cellulose acylate film. The additives to be used in the cellulose acylate film are preferably those not substantially evaporating in the drying step.

Preferably used herein are optical anisotropy controlling agents having an effect of not so much changing Rth of the film before heat treatment or lowering it, depending on the intended Re and Rth. Adding such additives may improve the mobility of the polymer molecules during heat treatment, and therefore the Re and the Rth expressibility of the cellulose acylate film produced according to the production method of the invention may be further controlled. Therefore, the high vaporization crystallization treatment temperature can be set relatively lower, or the expression of Re and Rth can be much increased.

From the viewpoint of reducing the humidity-dependent retardation change of the film, the amount of these additives to be added to the film is preferably larger, but with the increase in the amount to be added, there may occur some problems in that the glass transition temperature (Tg) of the cellulose acylate film may lower and the additives may evaporate away during the process of film production. Accordingly, in case where cellulose acetate which is preferably used in the invention is used as the polymer, then the amount of additives having the molecular weight of 50,000 or less to be added is preferably in the range of 0.01% to 30% by mass, more preferably in the range of 2% to 30% by mass, even more preferably in the range of 2% to 20% by mass relative to the polymer.

For the retardation regulating agents which can be suitably used in case that cellulose acylate is used in the invention, specifically, there can be exemplified described in JP-A-2005-104148 and in JP-A-2001-151901. For the IR absorbent, there can be exemplified described in JP-A-2001-194522. The time of adding the additives may be properly determined depending on the types of the additives.

### (3) Wavelength Dispersion Regulating Agent

Preferably, the wavelength dispersion characteristics of Re and Rth the cellulose acylate film fall within a specific range; concretely, Re (450 nm)−Re (550 nm) is less than −3 nm, or Rth (450 nm)−Rth (550 nm) is more than 3 nm. Falling within the range, the contrast viewing angle of the film is broadened. Re(λ nm) and Rth(λ Nm) mean the values of Re and Rth, respectively, at the wavelength of λ nm.

For producing the cellulose acylate film of which the wavelength dispersion satisfies the above-mentioned preferred range, preferably used is a wavelength dispersion regulating agent. The wavelength dispersion regulating agent in the invention is a compound having an absorption maximum in a wavelength range of from 250 to 400 nm. In particular, the wavelength dispersion regulating agent for use in the invention preferably has an absorption maximum in a wavelength range of from 300 to 380 nm, more preferably from 340 to 380 nm. By stretching the cellulose acylate film formed of a polymer having a negative birefringence and containing such a wavelength dispersion regulating agent, the wavelength dispersion characteristics of the film can be regulated. Specifically, the wavelength dispersion regulating agent can regulate the value of Re(450 nm) Re(550 nm) and the value of Rth(450 nm)−Rth(550 nm) of the film. The compound having an absorption maximum in a wavelength range of from 250 to 400 nm that serves as the wavelength dispersion regulating agent in the invention may absorb light in a wavelength range except the range of from 250 to 400 nm.

Preferably, the wavelength dispersion regulating agent for use in the invention is a compound that not substantially vaporizing in the entire process of formation of the cellulose acylate film and formation of polarizer and liquid crystal display device. One or more different types of wavelength dispersion regulating agents may be used herein either singly or as combined. The total amount of the wavelength dispersion regulating agent to be added may vary depending on the optical properties of the film and others, but is preferably from 0.1 to 20% by mass, more preferably from 0.1 to 15% by mass, even more preferably from 1 to 10% by mass, from the viewpoint of regulating Re(450 nm)−Re(550 nm) to less than −3 nm or regulating Rth(450 nm)−Rth(550 nm) to more than 3 nm. Preferably, the wavelength dispersion regulating agent is added to and mixed with the film-forming melt or solution before the film formation. Preferably, the wavelength dispersion regulating agent has a molecular weight of from 100 to 5000, more preferably from 150 to 3000, even more preferably from 200 to 2000.

Preferably, the wavelength dispersion regulating agent for use in the invention is a compound represented by any of the following general formulae (1) to (VII). Of formulae (I) to (VII), preferred are those of formulae (I), (II), (V) and (VI), and more preferred are those of formula (I) as readily regulating the value Re(450 nm)−Re(550 nm) and the value Rth (450 nm)−Rth (550 nm). One example of the compounds of formula (I) is a compound AA-1 of which the structure is shown in the section of Examples given below. Also preferred are compounds of formula (VII), and one example thereof is a commercially-available compound AB-1 of which the structure is shown in the section of Examples (concretely, TINOPAL OB (trade name by Ciba Japan).

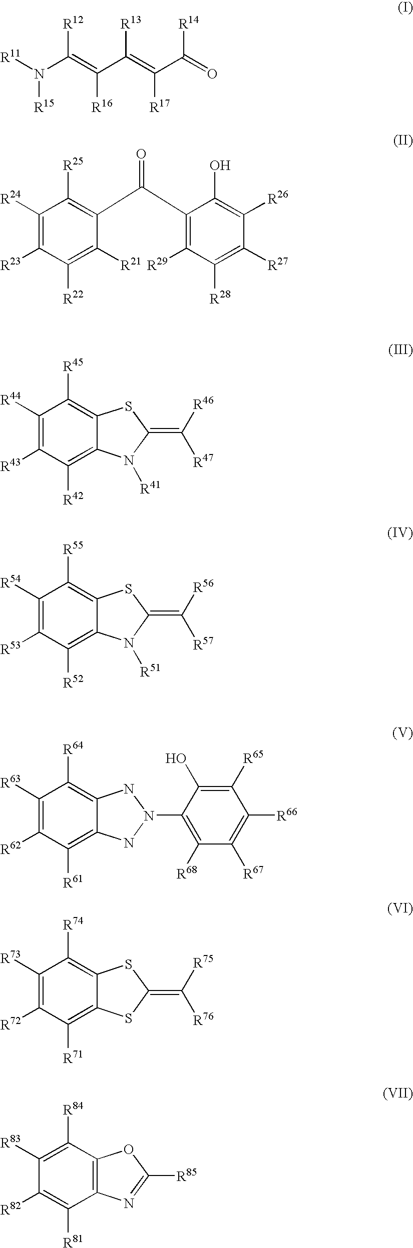

R¹¹, R¹², R¹³, R¹⁴, R¹⁵, R¹⁶, and R¹⁷ in formula (I); R²¹, R²², R²³, R²⁴, R²⁵, R²⁶, R²⁷, R²⁸, and R²⁹ in formula (II); R⁴¹, R⁴², R⁴³, R⁴⁴, R⁴⁵, R⁴⁶, and R⁴⁷ in formula (III); R⁵¹, R⁵², R⁵³, R⁵⁴, R⁵⁵, R⁵⁶, and R⁵⁷ in formula (IV); R⁶¹, R⁶², R⁶³, R⁶⁴, R⁶⁵, R⁶⁶, R⁶⁷, and R⁶⁸ in formula (IV); R⁷¹, R⁷², R⁷³, R⁷⁴, R⁷⁵ and R⁷⁶ in formula (VI); and R⁸¹, R⁸², R⁸³, R⁸⁴ and R⁸⁵ in formula (VII); each represent a hydrogen atom or a substituent group.

By selecting the type of the substitution group, the long axis of the molecule of the compound represented by any one of formulae (I)-(VII) may be adjusted to any direction. It is possible that the direction of the molecular long axis is adjusted to the horizontal direction of the paper plane.

Examples of the substituent group include halogen atoms (such as fluorine atom, chlorine atom, bromine atom and iodine atom); alkyls (preferably C₁₋₃₀, or more preferably C₁₋₁₀ substituted or non-substituted alkyls such as methyl, ethyl, n-propyl, isopropyl, tert-butyl, n-octyl and 2-ethylhexyl); cycloalkyls; bicycloalkyls; alkenyls; cycloalkenyls; bicycloalkenyls; alkynyls; aryls (preferably C₆₋₃₀ or more preferably C₆₋₁₀ substituted or non-substituted aryls such as phenyl, p-tolyl and naphthyl); heterocyclic group; cyano; hydroxyl; nitro; carboxyl; alkoxys (preferably C₁₋₃₀ or more preferably C₁₋₁₀ substituted or non-substituted alkoxys such as methoxy, ethoxy, isopropoxy, tert-butoxy, n-octyloxy and 2-methoxyethoxy); aryloxys; silyloxys; heterocyclic oxy group; acyloxys; carbamoyl oxy, group; alkoxy carbonyl oxy group; aryloxy carbonyl oxy group; aminos; acylamino group; amino carbonyl amino; alkoxy carbonyl aminos; aryloxy carbonyl amino group; sulfamoyl group; alkyl- and aryl-sulfonyl amino group; mercapto; alkylthio group; arylthio group; heterocyclic thio group; sulfamoyls; sulfo; alkyl- and aryl-sulfinyls; alkyl- and aryl-sulfonyls (preferably C₁₋₃₀ or more preferably C₁₋₁₀ substituted or non-substituted alkyl-sulfonyls; and preferably C₆₋₃₀ or more preferably C₆₋₁₀ substituted or non-substituted aryl-sulfonyls such as methylsulfonyl, ethylsulfonyl, phenylsulfonyl, and p-methylphenylsulfonyl); acyls; aryloxy carbonyl group; alkoxy carbonyl group; carbamoyls; aryl- and heterocyclic azo group; imido group; phosphino group; phosphinyl group; phosphinyl oxy group; phosphinyl amino group; and silyl group.

The substituents, which have at least one hydrogen atom, may be substituted by at least one substituent selected from these. Examples such substituent include alkylcarbonylaminosulfo, arylcarbonylaminosulfo, alkylsulfonylaminocarbonyl and arylsulfonylaminocarbonyl. More specifically, methylsulfonylaminocarbonyl, p-methylphenylsulfonylaminocarbonyl, acetylaminosulfonyl and benzoylaminosulfonyl are exemplified.

Among the examples described above, preferred are halogen atoms, alkyls, aryls, alkoxys, cyano, hydroxyl, carboxyls and arylsulfonyls; more preferred are alkyls, alkoxys, hydroxyl, carboxyls and phenylsulfonyls. Same or different two or more substituents may be selected. If possible, the substituents may bond to each other to form a ring which includes a condensed ring with the ring in the formula).

In addition to the above, other preferable embodiments of each substituent are described in JP-A-2009-262551.

The molecular-weight of the retardation enhancer to be used in the invention is preferably from 100 to 5000, more preferably from 150 to 3000, and even more preferably from 200 to 2000.

### (Preparation of Polymer Solution)

The polymer solution may be prepared, for example, according to the methods described in JP-A-58-127737, JP-A-61-106628, JP-A-2-276830, JP-A-4-259511, JP-A-5-163301, JP-A-9-95549, JP-A-10-45950, JP-A-10-95854, JP-A-11-71463, JP-A-11-302388, JP-A-11-322946, JP-A-11-322947, JP-A-11-323017, JP-A-2000-53784, JP-A-2000-273184 and JP-A-2000-273239. Concretely, cellulose acylate and solvent are mixed and stirred so that the cellulose acylate is swollen, and as the case may be, this is cooled or heated so as to dissolve the cellulose acylate, and thereafter this is filtered to obtain a cellulose acylate solution.

According to the invention, in order to improve solubility of cellulose acylate in a solvent, there is included a process of cooling and/or heating a mixture of cellulose acylate and a solvent.

In case of cooling the mixture of cellulose acylate and a solvent in which a halogen-containing organic solvent is used as the solvent, it is preferred to include a process of cooling the mixture at −100 to 10° C. Further, it is preferred to include a process of swelling the mixture at −10 to 39° C. before the process of cooling, and a process of heating the mixture at 0 to 39° C. after the process of cooling.

In case of heating the mixture of cellulose acylate and a solvent in which a halogen-containing organic solvent is used as the solvent, it is preferred to include a process of dissolving the cellulose acylate in the solvent according to at least one of the following methods (a) and (b).

(a): A mixture is swollen at −10 to 39° C., and then heated at 0 to 39° C.

(b): A mixture is swollen at −10 to 39° C., and then heated at 40 to 240° C. under pressure of 0.2 to 30 MPa. After that, the mixture is cooled at 0 to 39° C.

In addition, in case of cooling the mixture of cellulose acylate and a solvent in which a non-halogen-containing organic solvent is used as the solvent, it is preferred to include a process of cooling the mixture at −100 to −10° C. Further, it is preferred to include a process of swelling the mixture at −10 to 55° C. before the process of cooling, and a process of heating the mixture at 0 to 57° C. after the process of cooling.

In case of heating the mixture of cellulose acylate and a solvent in which a non-halogen-containing organic solvent is used as the solvent, it is preferred to include a process of dissolving the cellulose acylate in the solvent according to at least one of the following methods (c) and (d).

(c): A mixture is swollen at −10 to 55° C., and then heated at 0 to 57° C.

(d): A mixture is swollen at −10 to 55° C., and then heated at 40 to 240° C. under pressure of 0.2 to 30 MPa. After that, the mixture is cooled at 0 to 57° C.

### [Production of Web]

The cellulose acylate film may be produced by a conventional method of solution casting film formation, using a conventional apparatus for solution casting film formation. Concretely, a dope (polymer solution) prepared in a dissolver (tank) is filtered, and then once stored in a storage tank in which the dope is degassed to be a final dope. The dope is kept at 30° C., and fed into a pressure die from the dope discharge port of the tank, via a metering pressure gear pump through which a predetermined amount of the dope can be fed with accuracy, for example, based on the controlled revolution thereof, and then the dope is uniformly cast onto the metal support of a casting unit that runs endlessly, via the slit of the pressure die (casting step). Next, at a peeling point at which the metal support reaches almost after having traveled round the drum, a semi-dried dope film (this may be referred to as a web) is peeled from the metal support, conveyed to a drying zone wherein the drying is completed while the web is conveyed with rolls. The casting step and the drying step in the solution casting film formation method are also described in JP-A 2005-104148, page 120-146, which may be applied to the invention.

In the invention, the metal support used in the formation of the web may be a metal band or a metal drum.

In the invention, the prepared polymer solution may be cast onto a smooth band or drum serving as a metal support, as a single-layer solution; or plural cellulose acylate solutions for 2 or more layers may be co-cast thereon. In case where plural cellulose acylate solutions are co-cast, the cellulose acylate-containing solution may be cast onto a metal support through plural casting mouths disposed around the support at intervals in the machine direction (film conveying direction), and the co-cast solutions may be laminated on the support to give a film. For example, the methods described in JP-A 61-158414, 1-122419, 11-198285 are employable.

The polymer solution may be cast through two casting mouths to form a film, for which, for example, employable are the methods described in JP-B 60-27562, JP-A 61-94724, 61-947245, 61-104813, 61-158413, 6-134933. Also employable herein is a cellulose acylate film co-casting method of casting a flow of a high-viscosity cellulose acylate solution as enveloped with a low-viscosity cellulose acylate solution thereby simultaneously extruding both the high-viscosity and low-viscosity cellulose acylate solutions, as in JP-A56-162617. Also preferred is an embodiment where the outer solution contains a larger amount of a poor solvent, alcohol than in the inner solution, as in JP-A 61-94724, 61-94725. Two casting mouths may be used as follows: A film is formed on a metal support through the first casting mouth, then this is peeled, and on the other surface of the film opposite to that having kept in contact with the metal support, another film is formed through the second casting mouth. For example, the method is described in JP-B 44-20235. The polymer solutions to be cast may be the same or different with no specific limitation. In order to make the plural cellulose acylate layers have various functions, polymer solutions corresponding to the desired functions may be cast through the respective casting mouths. The cellulose acylate solution may be cast along with any other functional layers (e.g., adhesive layer, dye layer, antistatic layer, antihalation layer, UV absorbent layer, polarizing layer).

In case where a single-layer film is formed according to a conventional technique, a high-concentration and high-viscosity polymer solution must be extruded out in order to make the formed film have a desired thickness; but in such a case, the stability of the polymer solution is poor therefore causing various problems of solid deposition to be fish eyes or to roughen the surface of the film. For solving the problems, plural polymer solutions are cast out through different casting mouths, whereby high-density solutions can be extruded out at the same time on a metal support, and as a result, the surface properties of the formed films are bettered and films having excellent surface properties can be produced. In addition, since such thick polymer solutions can be used and the drying load in the process can be reduced, and the film producibility is enhanced.

In co-casting, the thickness of the outer layer and the inner layer is not specifically defined. Preferably, the thickness of the outer layer is from 1 to 50% of the overall thickness of the film, more preferably from 2 to 30%. In co-casting of three or more layers, the total thickness of the layer adjacent to the metal support and the outermost layer adjacent to air is defined to be the thickness of the outer layer. In another embodiment of co-casting, polymer solutions in which the density of the additives such as the above-mentioned plasticizer, UV absorbent, mat agent and the like differs may be co-cast to produce a cellulose acylate film having a laminate structure. For example, a cellulose acylate film having a constitution of skin layer/core layer/skin layer can be produced. For example, the mat agent may be much in the skin layer, or may be only in the skin layer. The plasticizer and the UV absorbent may be more in the core layer than in the skin layer, or may be only in the core layer. The type of the plasticizer and the UV absorbent may differ between the core layer and the skin layer. For example, a low-volatile plasticizer and/or UV absorbent may be in the skin layer, and a plasticizer of excellent plasticization or a UV absorbent of excellent UV absorption may be added to the core layer. An embodiment of adding a release agent to only the skin layer on the side of the metal support is also preferred. In order to gel the solution by cooling the metal support in a cooling drum method, alcohol as a poor solvent may be more in the skin layer than in the core layer, and this is also a preferred embodiment. Tg may differ between the skin layer and the core layer. Preferably, Tg of the core layer is lower than that of the skin layer. The viscosity of the cellulose ester solution to be cast may differ between the skin layer and the core layer. Preferably, the viscosity of the solution for the skin layer is smaller than that for the core layer; however, the viscosity of the solution for the core layer may be smaller than that for the skin layer.

### <First Stretching Step>

In the cellulose acylate film production method of the invention, the web formed in the previous casting step is, while conveyed, stretched in one direction at −30° C. to 30° C. while the residual solvent amount therein is kept falling between 100 and 300% by mass. Preferably, the web is stretched in the machine direction in the first stretching step from the viewpoint of the Re expressibility of the resulting film. In this stage, the residual solvent amount in the wet at the start of the first stretching is from 100 to 300% by mass. The preferred temperature range in the first stretching step is from −30° C. to 30° C., more preferably from −10° C. to 0° C.

### (Residual Solvent Amount)

The residual solvent amount of the cellulose acylate web at the beginning of the first stretching may be represented by the following formula. The residual solvent amount of the cellulose acylate web after the drying step or at the beginning of the second stretching step may also be represented by the following formula:

Residual Solvent Amount (% by mass)=((M−N)/N)×100

[in the formula, M means the mass of the cellulose acylate film just before inserted into the stretching zone; and N means the mass of the cellulose acylate film just before inserted into the stretching zone, dried at 120° C. for 2 hours].

In the first stretching step in the invention, the residual solvent amount in the web at the start of the first stretching is from 100 to 300% by mass, but is preferably from 200 to 300% by mass in consideration of the balance in peeling, the web condition, the stretching temperature, the draw ratio in stretching, etc. In case where the residual solvent amount in the web at the start of the first stretching is less than 100% by mass, then the web being stretched may be broken at a low stretching temperature. Accordingly, the stretching temperature must be high and the energy efficiency may lower. Even when the stretching temperature is elevated, the web being stretched at a high draw ratio may also be broken. Further, when the residual solvent amount is less than 100% by mass, the film may be hard and may be hardly stretched, and therefore the stretched film could not have the desired optical properties. On the other hand, when the residual solvent amount is more than 300% by mass, then the web peelability may worsen, the web stretching aptitude may worsen (as the web is often wrinkled and is difficult to handle), and the web recovery performance may greatly worsen. In particular, when the residual solvent amount is from 200 to 300% by mass, the draw ratio may be increased with ease and the web may be more effectively prevented from cut or broken.

The residual solvent amount in the cellulose acylate wave at the start of the first stretching step may be suitably controlled by controlling the concentration of the polymer solution, and controlling the temperature and the speed of the metal support in the invention. Before the start of the first stretching step, the web may be dried; however, the drying before the start of the first stretching step must be at a temperature at which the web is not crystallized. Concretely, the web may be dried at a temperature not higher than 30° C.

During the first stretching step, the residual solvent amount in the cellulose acylate web gradually decreases, and at the end of the first stretching step, preferably, the residual solvent amount is lowered to the level at the start of the next drying step. For example, in the first stretching step, the residual solvent amount may be controlled in such a preferred manner through spontaneous drying of the web being stretched, or by introduction of dry air to the web being stretched, whereby the web may be dried at the same time of stretching it.

In the first stretching step in the invention, the web is stretched in the machine direction while conveyed. In this stage, the draw ratio of the web is preferably from 5 to 100%, more preferably from 15 to 50% from the viewpoint of attaining the high draw ratio in stretching and preventing the web from being broken. The draw ratio (elongation) of the cellulose acylate web in stretching may be attained by the peripheral speed difference between the metal support speed and the peeling speed (peeling roll draw). For example, in case where an apparatus having two nip rolls is used, the rotation speed of the nip roll on the outlet port side is made higher than the rotation speed of the nip roll on the inlet port side; whereby the cellulose acylate web can be preferably stretched in the traveling direction (machine direction). According to the stretching mode, the retardation expressibility of the resulting film can be controlled.

The “draw ratio (%)” as referred to herein can be computed according to the following formula; however, this is not limited to the method of directly measuring the length, but any other method capable of producing the same result as the draw ratio to be computed according to the formula mentioned below may be employed for it.

Draw Ratio (%)=100×{(length after stretching)−(length before stretching)}/(length before stretching).

In the first stretching step in the invention, the surface temperature of the web being stretched (stretching temperature) is controlled to be from −30° C. to 30° C. from the viewpoint of securing the stretching efficiency and reducing the residual solvent amount fluctuation. The web temperature control may be attained by controlling the metal support temperature and the zone temperature.

Not specifically defined, the drawing speed in the stretching step is preferably from 1 to 1000%/min, more preferably from 1 to 100%/min, from the viewpoint of the stretching aptitude (no wrinkling, good handlability). The web may be stretched in one stage or in multiple stages.

After the first stretching step, the web is then conveyed to the next drying (crystallization treatment) step.

### <Drying (Crystallization Treatment) Step>

After the stretching treatment, the web is then treated in the next drying step of reducing the residual solvent amount from the condition thereof of from 6 to 120% by mass to a condition of less than 12% by mass while controlling the surface temperature of the web so as not to reach 200° C. or higher (crystallization treatment).

Under the condition satisfying the above-mentioned requirements, the molecular movement inside the cast web is sufficient even at such a low temperature, and in addition, the number of the molecules detracting from the crystallization is sufficiently small under the crystallization condition, and therefore, the crystallization efficiently goes on at a low temperature. In case where the web surface temperature is lower than the above, the molecular movement could not be sufficient; but when higher, the molecular movement may be too great and the crystallization could not go on.

After the first stretching step, the web surface temperature is more preferably controlled to be from 50 to 150° C., even more preferably from 50 to 120° C. in the drying step, from the viewpoint of the optical expressibility of the resulting film.

At the start of the drying step, the residual solvent amount is from 6 to 120% by mass, preferably from 8 to 100% by mass, more preferably from 10 to 100% by mass, even more preferably from 20 to 100% by mass. When the residual solvent amount is at most 120% by mass, preferably at most 100% by mass, the molecular movement may be sufficient and the number of the molecules that inhibit the crystallization may increase, and therefore the crystallization may be easy. When the residual solvent amount is at least 6% by mass, preferably at least 8% by mass, more preferably at least 10% by mass, the molecular movement may be satisfactory at a low temperature.

At the end of the drying step, the residual solvent amount is less than 12% by mass, preferably from 2 to 10% by mass, even more preferably from 2 to 7% by mass.

In the production method of the invention, preferably, the residual solvent amount of from 8 to 100% by mass is reduced to from 2 to 10% by mass in the drying step.

Preferably, the reduction in the residual solvent amount in the drying step is from 3 to 98% by mass, more preferably from 10 to 60% by mass, even more preferably from 20 to 50% by mass.

A step of reducing the residual solvent amount to at most 100% by mass may be effected simultaneously with the stretching in the previous first stretching step between the start of the first stretching step to the start of the drying step.

In case where the residual solvent amount is not controlled to fall within the preferred range at the end of the first stretching step and before the start of the drying step, an additional step of reducing the residual solvent amount is effected after the end of the first stretching step and before the start of the drying step. The step of reducing the residual solvent amount may be a drying step not opposing the object and the spirit of the invention, like the drying before the start of the first stretching step mentioned above. Concretely, the web may be dried at a drying temperature not higher than 50° C.

As another step of reducing the residual solvent amount, concretely mentioned is, for example, the following embodiment, to which, however, the invention should not be limited. In a tenter, for preventing the web itself from foaming or preventing it from adhering to a holding unit, it is desirable that the pins of holding both sides of the web are cooled to a temperature lower than the web foaming temperature by an air-blowing cooler in the tenter drier and the pins just before the site where the web begins to be held by them are cooled to 0° C. or lower by the dope in the duct-type cooler.

Preferably, the drying (crystallization) treatment in the production method of the invention is attained while the cellulose acylate film is conveyed. The method of conveying the cellulose acylate film is not specifically defined, and the web is held in its both edge by tenter clips or pin tenter and dried in the drying (crystallization) treatment. Typical embodiments include a method of conveying the film by nip rolls or suction drums; a method of conveying the film while held by tenter clips, and a method of flowing and conveying the film by pneumatic pressure. Preferred is the method of conveying the film while held in its both edge by a pin tenter or the method of conveying the film by the plural conveyor rollers spaced narrowly from each other, and more preferred is the method of conveying the film while held in its both edge by a pin tenter.

The method of conveying the web while fixed with a pin tenter is concretely effected by fixing the two edges of the cellulose acylate web on the line perpendicular to the machine direction with a pin tenter, and conveying the web while controlling the distance between the tenter by which one side is fixed and the tenter by which the other side is fixed. The tenter-to-tenter distance may be controlled by suitably defining the tenter rail pattern. By controlling the distance between the tenters in the manner as above, the cellulose acylate web can be dried while controlling the dimensional change in the cross direction to a desired level.

For preventing the web from being cut or broken or wrinkled and for preventing the conveyance failure, preferably, the inside pin density is large and the outside pin density is small in the pin tenter.

The method of conveying the web by plural conveyor rollers spaced narrowly from each other is concretely effected by leading a cellulose acylate web to pass through the space between plural conveyor rollers installed inside a crystallization treatment zone in such a manner that the adjacent conveyor rollers are spaced from each other by a distance of from 0.1 cm to 50 cm. The distance between the adjacent conveyor rollers is meant to indicate the distance in which the traveling web runs from leaving from one conveyor roll to reaching the next conveyor roll. By leading the web to pass through such a group of conveyor rolls that are spaced narrowly from each other (so-called dense rolls), the retention power of the conveyor rolls acts on the cross direction of the web to thereby reduce the dimensional change in the cross direction of the web. According to the method, the web could not be expanded in the cross direction like in a tenter clip method is impossible, but the shrinkage of the web could be minimized.

The film-traveling speed in the drying (crystallization) treatment is generally from 1 to 500 m/min, preferably from 5 to 300 m/min, more preferably from 10 to 200 m/min, even more preferably from 20 to 100 m/min. When the film-traveling speed is at least the above-mentioned lowermost limit, 1 m/min, then the method is favorable as capable of securing a sufficient industrial producibility; and when it is at most the above-mentioned highest limit of 500 m/min, then the method is also favorable for the capability of good crystal growth promotion within a crystallization treatment zone length. When the film-traveling speed is higher, then the film coloration may be prevented more; and when it is lower, the crystallization treatment zone length may be shorter. Preferably, the film-traveling speed during heat treatment (the device speed of the nip rolls and the suction drum that determines the film-traveling speed) is kept constant.

The drying (crystallization) treatment in the production method of the invention includes, for example, a method of leading a cellulose acylate film to run in a zone having a temperature T while transported through it; a method of applying hot air to a cellulose acylate film being transported; a method of irradiating a cellulose acylate film being transported with heat rays; and a method of contacting a cellulose acylate film with a heated roll.

Preferred is the method of leading a cellulose acylate film to run in a zone having a temperature T, to which a hot air is sent, while transported through it. According to the method, a cellulose acylate film may be heated uniformly, which is an advantage. The temperature inside the zone may be controlled and kept constant at T by a heater while monitoring with, for example, a temperature sensor. The traveling length of the cellulose acylate film running in the zone at a temperature T may vary depending on the property of the cellulose acylate film to be produced and on the film-traveling speed; but in general, it is preferably so set that the ratio of (traveling length)/(width of the traveling cellulose acylate film) could be from 0.1 to 100, more preferably from 0.5 to 50, even more preferably from 1 to 20. In this description, the ratio may be referred to as an aspect ratio. The film-running time in the zone at a temperature T (crystallization treatment time) may be generally from 0.01 to 60 minutes, preferably from 0.03 to 10 minutes, more preferably from 0.05 to 5 minutes. Within the range, the retardation expressibility may be excellent and the processed film may be prevented from being colored.

For preventing the reduction in the quality such as the surface smoothness of the film by increasing the speed in solution casting or by expanding the width of the web by the use of a tenter, it is desirable that, when the web is dried in a tenter in the drying step, the air velocity is from 0.5 to 20 (40) m/sec, the temperature distribution in the cross direction is at most 10% and the blast ratio between the above and the below of the web is from 0.2 to 1.

The air velocity distribution on the web surface positioned in the extended direction from the drying gas blast direction is, when based on the uppermost limit of the air speed, preferably such that the difference between the uppermost limit and the lowermost limit is within 20%, and under the condition, dry gas is belched out to dry the web.

In the production method of the invention, the drying (crystallization treatment) step may be effected once or plural times. “Effecting the step plural times” means that after the previous drying (crystallization treatment) step, the web is again heated up to a temperature lower than 200° C. but higher than the temperature at the end of the previous heating (crystallization treatment step), and while conveyed, it is again processed for crystallization treatment. In case where the web is processed plural times for crystallization treatment, it is desirable that the stretching draw ratio satisfies the above-mentioned range after the stage of all the crystallization treatment steps. Preferably in the production method of the invention, the crystallization treatment is effected at most three times, more preferably at most two times, and most preferably, it is effected once.

### [Second Stretching Step]

The production method of the invention includes, after the drying step, a second stretching step of stretching the film at 60° C. to 200° C. in the direction different from the stretching direction in the previous first stretching step.

The stretching temperature in the second stretching step is from 60 to 200° C., preferably from 90 to 140° C. When the stretching temperature is 60° C. or higher, then the film can be stretched sufficiently, and when it is not higher than 200° C., the problem of additive bleeding or evaporation is noticeably evaded.

It is considered that, by effecting the second stretching under the condition as above, the oriented amorphous part may be reduced not significantly moving the crystal part. Accordingly, not significantly changing Re, the humidity dependence of Re can be reduced. In addition, the wavelength dispersion characteristics of the film can be controlled. In the second stretching step, preferably, the film is stretched in the direction different from the machine direction, or that is, in the direction perpendicular to the machine direction from the viewpoint of efficiently reducing the oriented amorphous part.

Also preferably, the film is stretched in TD (transverse direction, or that is, the direction perpendicular to the machine direction, or the film traveling direction), from the viewpoint of effectively reducing the humidity dependence of the retardation (especially Re) of the transparent film to be finally obtained. The reduction in the humidity dependence reduces the humidity change-dependent display fluctuation and therefore enhances the display stability.

By effecting the second stretching step that satisfies the above-mentioned condition after the drying step, the humidity dependence of the obtained film may be reduced and the wavelength dispersion characteristics thereof can be controlled. The humidity dependence and the wavelength dispersion characteristics of the film are governed mainly by the orientation of the amorphous part and the additive (wavelength dispersion regulating agent). On the other hand, the direction of the slow axis of the film and the absolute values of Re and Rth thereof are governed mainly by the orientation of the crystal part. The orientation direction of the film before stretching is investigated. In the film processed for crystallization treatment alone, the crystal part, the amorphous part and the additive are oriented in the machine direction in the crystallization treatment step. The invention is characterized in that, after the drying (crystallization treatment) step, the film is processed in the second stretching step within the above-mentioned specific range. The invention is based on the characteristic finding that, in the stretching after the drying step, the speed of changing the orientation of the amorphous part and the additive is higher than the speed of changing the orientation of the crystal part. Specifically, by the stretching, the orientation of the amorphous part and others can be dominantly changed not significantly moving the crystal part. According to the production method of the invention, by the stretching after the drying (crystallization treatment) step, the orientation of the amorphous part and the additive can be made to be perpendicular to the orientation of the crystal part, and not changing the direction of the slow axis, the humidity dependence and the wavelength dispersion characteristics of the film can be freely controlled.

In case where the second stretching step is for TD stretching, as the method of TD stretching, for example, employable is a method comprising fixing both sides of the cellulose acylate film with a pin tenter, and leading it to pass through a heating zone while it is stretched or contracted in the direction (transverse direction) perpendicular to the machine direction. The TD stretching may be effected in one stage or in multiple stages. Preferred is a method of holding both sides of the polymer film with a pin tenter and expanding the film in the direction perpendicular to the machine direction to thereby stretch the film.

The draw ratio in the second stretching step may be suitably determined in accordance with the necessary retardation of the cellulose acylate film, and is preferably less than 35%, more preferably from 1% to less than 35%, even more preferably from 1 to 30%, still more preferably from 1 to 5%.

The drawing speed in the TD stretching is preferably from 1 to 1000%/min, more preferably from 10 to 500%/min, even more preferably from 10 to 200%/min.

After the drying (crystallization treatment) step, Re and Rth of the cellulose acylate film before the second stretching step are not specifically defined.

### (Post-Drying, Handling)

In the cellulose acylate film production method of the invention, the drying temperature in the drying step after the end of the second stretching step is preferably from 40 to 180° C., more preferably from 70 to 150° C. For further removing the residual solvent, the film is dried at 50 to 150° C., and in such a case, preferably, the film is dried with high-temperature air of which the temperature is gradually changed to thereby evaporate away the residual solvent. The method is described in JP-B 5-17844. Depending on the solvent used, the drying temperature, the drying blast amount and the drying time may vary, and may be suitably selected in accordance with the type of the solvent used and the combination of the conditions. The residual solvent amount in the final film is preferably at most 2% by mass, more preferably at most 0.4% by mass for good dimensional stability of the film.

Regarding the residual solvent amount in the dried film, JP-A 2002-241511 describes as follows: Even in a thin film having a thickness of from 20 to 60 μm, the residual solvent amount in winding it is preferably at most 0.05% by mass for the purpose of preventing the film from deforming with time, making the film optically isotropic, making the film resistant to scratching and making the film contain neither bubbles nor insoluble matter. Also preferably, the difference between the maximum value and the minimum value of the residual solvent amount in the cross direction of the film is at most 0.02% by mass, and the residual solvent amount in the film is preferably at most 0.04% by mass, more preferably at most 0.02% by mass; and for this, preferably, the drying temperature is from 100 to 150° C. and the drying time is from 5 to 30 minutes.

Within a range with no problem of additive bleeding and evaporation, the film may be further processed at a temperature of around 200° C. or so for further increasing the degree of crystallinity thereof, after the second stretching step.

For stable transportation, for bettering surface condition, for securing necessary optical characteristics and for reducing thermal shrinkage, JP-A 2003-053751 describes an invention in which, when the residual solvent amount (based on the dry amount) in the base in dry is from 3 to 7% by mass, the proportion of the poor solvent in the residual solvent amount is from 0.01 to 95% by mass.

JP-A 2003-071863 for an invention of obtaining a non-fogging film says that, in the film drying step, the film peeled from the belt is preferably further dried so that the residual solvent amount is reduced to at most 0.5% by mass, more preferably at most 0.1% by mass, most preferably from 0 to 0.01% by mass.

JP-A 5-278051 describes an invention of a solution casting method for film formation, in which, for the purpose of producing a film having physical properties of little difference in solute between the surface and the back thereof with good producibility, the solute is so selected that the interaction parameter χ between the solute and the polymer could be at most 0.9 and the film is dried until the ratio by weight of the polymer to the solvent in the cast film could be at most 23% while the ratio by weight of the polymer to the solvent in the film surface is kept to be at least 12%.

The above-mentioned inventions are all applicable to the present invention.

The process from casting to post-drying may be effected in an air atmosphere or in an inert gas atmosphere such as nitrogen gas. For drying, far-infrared rays may be used, or as in JP-A 8-134336, 8-259706 and 8-325388, microwaves may be used for drying.

JP-A 2002-283370 describes a technique of removing dust adhering to the web by disposing a film-cleaning device before introduction and/or after taking out of the film from the drying device or the thermal curing device. As the cleaning measures, the patent publication discloses various systems of flame treatment (corona treatment, plasma treatment) of systems of disposing adhesive rolls, as the method except vibration, high-pressure blasting or suction. As a preferred embodiment for preventing further contamination of the films with other impurities, the patent publication discloses installation of a discharger in a position at which the film is wound around an original wiring core, in which the discharger is so designed that the charged potential of the film once unwound from the original winding roll could be given a reversed potential of <±2 KV by a discharging device or a forced charging device in rewinding, and the forced charging potential could be discharged by the discharger for alternative positive/negative conversion of from 1 to 150 Hz, and an ionizer or a discharge bar capable of generating ionic air is utilized.

### <<Cellulose Acylate Film>>

Preferably, the cellulose acylate film obtained according to the production method of the invention has an optical characteristic of Nz (Nz=Rth/Re+0.5) of from 0 to 1.5, and is resistant to additive vaporization and bleeding. The cellulose acylate film is characterized in that it is produced by the cellulose acylate production method of the invention. When Nz is from 0 to 1.5, the contrast viewing angle in oblique directions of polarizer may be broadened.

The cellulose acylate film is described below.

### [Property of the Cellulose Acylate Film]

### (Retardation)

In this description, Re and Rth (unit: nm) are obtained according to the following method. A film to be analyzed is conditioned at 25° C. and a relative humidity of 60% for 24 hours. Using a prism coupler (Model 2010 Prism Coupler, by Metricon) and using a solid laser at 532 nm, the mean refractivity (n) of the film, which is represented by the following formula (1), is obtained at 25° C. and a relative humidity of 60%.

n=(n_{TE}×2+n_{TM})/3 (1)

wherein n_{TE} is the refractive index measured with polarized light in the in-plane direction of the film; and n_{TM} is the refractive index measured with polarized light in the normal direction to the face of the film.

In this description, Re(λ) and Rth(λ) are retardation in plane (nm) and retardation along the thickness direction (nm), respectively, at a wavelength of λ. Re(λ) is measured by applying light having a wavelength of λ nm to a film in the normal direction of the film, using KOBRA 21ADH or WR (by Oji Scientific Instruments).

When a film to be analyze by a monoaxial or biaxial index ellipsoid, Rth(λ) of the film is calculated as follows.

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above instance, when the retardations are expressed as Re and Rth without referring to specific λ, they are the values measured by use of the light in the wavelength of 590 nm. In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (2) and (3):

$$\begin{matrix}R e ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} & ( 2 ) \\ Rth = [ \frac{nx + ny}{2} - nz ] \times d & ( 3 )\end{matrix}$$

wherein Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the sample.

When the film to be analyzed is not expressed by a monoaxial or biaxial index ellipsoid, or that is, when the film does not have an optical axis, then Rth(λ) of the film may be calculated as follows.

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation 1.0 values, the estimated value of the mean refractive index and the inputted film thickness value, Rth(λ) of the film may be calculated by KOBRA 21ADH or WR. KOBRA 21ADH or WR calculates nx, ny and nz, upon enter of the hypothetical values of these mean refractive indices and the film thickness. Base on thus-calculated nx, ny and nz, Nz=(nx−nz)/(nx−ny) is further calculated.

Preferably, Re (550) of the cellulose acylate film is from 60 to 300 nm.

Preferably, Rth (550) of the cellulose acylate film is from −10 to 80 nm.

More preferably, the optical characteristics of the cellulose acylate film are as follows:

60 nm≦Re(550)≦200 nm,

−10 nm≦Rth(550)≦80 nm,

0.5<Nz<1.5,

even more preferably,

60 nm≦Re(550)≦150 nm,

40 nm≦Rth(550)≦80 nm,

1.0<Nz<1.5.

The wavelength dispersion characteristics of the in-plane retardation Re and the thickness-direction retardation Rth are important in optimizing the contrast viewing angle and coloration resistance of the film, therefore preferably satisfying the following:

Re(450)−Re(550)<−3 nm,

Rth(450)−Rth(550)>3 nm,

more preferably,

−40 nm<Re(450)−Re(550)<−5 nm,

5 nm<Rth(450)−Rth(550)<30 nm.

### (Humidity Dependency)

In the invention, the humidity dependency of Re and the humidity dependency of Rth are computed from the in-plane and thickness-direction retardation at a relative humidity H (unit, %), Re(H %) and Rth(H %). Re(H %) and Rth(H %) are as follows: The film to be analyzed is conditioned at 25° C. and a relative humidity H % for 24 hours, then at 25° C. and relative humidity H %, the retardation of the film at a relative humidity H % and a wavelength 590 nm is determined according to the above-mentioned method; and from the data, Re(H %) and Rth(H %) are computed. Mere expression Re alone, not accompanied by a value of relative humidity, means the data measured at a relative humidity 60%.

The retardation values of the cellulose acylate film, as measured under different humidity conditions, preferably satisfy the following relational formulae:

|Re(10%)−Re(80%)|<50, and

|Rth(10%)−Rth(80%)|<50.

More preferably, they satisfy the following relational formulae:

|Re(10%)−Re(80%)|<30, and

|Rth(10%)−Rth(80%)|<40.

Even more preferably, they satisfy the following relational formulae:

|Re(10%)−Re(80%)|<20, and

|Rth(10%)−Rth(80%)|<30.

Also preferably, the retardation value of the cellulose acylate film, as measured under different humidity conditions, preferably satisfies the following relational formula:

|Re(10%)−Re(80%)|/Re<1.

More preferably, it satisfies the following relational formula:

|Re(10%)−Re(80%)|/Re<0.5.

Even more preferably, it satisfies the following relational formula:

|Re(10%)−Re(80%)|/Re<0.3.

Most preferably, it satisfies the following relational formula:

|Re(10%)−Re(80%)|/Re<0.2.

Controlling the retardation values under different humidity conditions makes it possible to reduce the retardation change in varying external environments, thereby providing liquid crystal display devices of high reliability.

### (Slow Axis)

Preferably, in the cellulose acylate film, the angle, θ, between the machine direction in the production of the film and the slow axis of Re of the film is crossed. The angle is preferably 0±10° or 90±10°, more preferably 0±5° or 90±5°, even more preferably 0±3° or 90±3°, as the case may be, still more preferably 0±1° or 90±1°, most preferably 90±1°.

### (Film Thickness)

Preferably, the thickness of the cellulose acylate film is from 20 μm to 180 μm, more preferably from 30 μm to 160 μm, even more preferably from 40 μm to 120 μm. When the film thickness is at least 20 μm, then the film is favorable in point of the handlability thereof in working the film into polarizer or the like and of the ability thereof to prevent curling of polarizer. Also preferably, the thickness unevenness of the cellulose acylate film is from 0 to 2% both in the film-traveling direction and in the cross direction, more preferably from 0 to 1.5%, even more preferably from 0 to 1%.

### (Moisture Permeability)

The moisture permeability of the cellulose acylate film is preferably at least 100 g/(m²·day) in terms of the film having a thickness of 80 μm. Having the moisture permeability of at least 100 g/(m²·day) in terms of the film having a thickness of 80 μm, the film may be readily stuck to a polarizing film. The moisture permeability in terms of the film having a thickness of 80 μm is more preferably from 100 to 1500 g/(m²·day), even more preferably from 200 to 1000 g/(m²·day), still more preferably from 300 to 800 g/(m²·day).

In case where the cellulose acylate film is used as an outer protective film that is not disposed between a polarizing film and a liquid crystal cell as in the embodiment described below, the moisture permeability of the cellulose acylate film is preferably less than 500 g/(m²·day) in terms of the film having a thickness of 80 μm, more preferably from 100 to 450 g/(m²·day), even more preferably from 100 to 400 g/(m²·day), most preferably from 150 to 300 g/(m²·day). Within the range, the durability of polarizer to moisture or to wet heat may be improved, and liquid crystal display devices of high reliability can be provided.

### (ΔHc)

Preferably, the heat of crystallization ΔHc of the cellulose acylate film is from 0 to 1.0 J/g, more preferably from 0 to 0.5 J/g. Within the range, the Re expressibility of the film can be expanded and the humidity dependence of Re thereof can be reduced.

### (Coloration)

Preferably, the cellulose acylate film is colored little and is excellent in colorless transparency. Concretely, the absorption at 400 nm of the film is at most 0.2, more preferably at most 0.1.

### <<Retardation Film>>

The cellulose acylate film may be used as the support of a retardation film, and an optically anisotropic layer of a liquid crystal composition may be formed thereon to construct a retardation film. The optically anisotropic layer to be applied to the retardation film is formed of a composition containing a liquid crystal compound.

The liquid crystal compound is preferably a discotic liquid crystal compound or a rod-like liquid crystal compound.

### [Support of Retardation Film]

The retardation film has the cellulose acylate film as the support thereof. The cellulose acylate film may be used therein directly as it is, or after surface-treated in the manner to be mentioned below, the film may be used as the support.

### [Liquid Crystal Composition]

The liquid crystal composition for forming the optically anisotropic layer of the liquid crystal composition is preferably a liquid crystal composition capable of forming a nematic phase or a smectic phase. Liquid crystal compounds are generally grouped into rod-shaped and discotic liquid crystal compounds based on the morphology of the molecules thereof. In the invention, any of those liquid crystal compounds are usable.

The thickness of the optically anisotropic layer of the liquid crystal composition is not defined, preferably from 0.1 to 10 μm, more preferably from 0.5 to 5 μm.

### [Material for the Optically Anisotropic Layer of the Liquid Crystal Composition]

### (1) Discotic Liquid Crystalline Compound

Examples of the discotic liquid crystalline compound usable in the invention are described in various publications (e.g., C. Destrade et al., Mol. Cryst. Liq. Cryst., Vol. 71, page 111 (1981); Quarterly Outline of Chemistry, No. 22, Chemistry of Liquid Crystal, Chap. 5, Chap. 10, Sec. 2 (1994), by the Chemical Society of Japan; B. Kohne et al., Angew. Chem. Soc. Chem. Comm., page 1794 (1985); J. Zhang et al., J. Am. Chem. Soc., Vol. 116, page 2655 (1994)).

Preferably, the discotic liquid crystalline molecules are fixed as aligned in the optically anisotropic layer; and most preferably, they are fixed through polymerization. The polymerization of discotic liquid crystalline molecules is described in JP-A-8-27284. For fixing discotic liquid crystalline molecules through polymerization, it is necessary that a substituent of a polymerizing group is bonded to the disc core of the discotic liquid crystalline molecules. However, when a polymerizing group is directly bonded to the disc core, then the molecules could hardly keep their alignment condition during the polymerization. Accordingly, a linking group is introduced between the disc core and the polymerizing group. The discotic liquid crystalline molecules having a polymerizing group are disclosed in JP-A-2001-4387.

As a discotic liquid crystal compound to be used for preparing the first optically anisotropic layer, the compounds described in JPA No. 2000-76992, [0052], JPA No. 2007-2220, [0040] to [0063], are suitable. Among the compounds, the compounds exhibiting a discotic liquid crystallinity are preferable, and the compounds having a discotic-nematic phase are more preferable.

### (2) Rod-Shaped Liquid Crystalline Compound

Examples of the rod-shaped liquid crystalline compound usable in the invention are azomethines, azoxy compounds, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, tolans and alkenylcyclohexylbenzonitriles. However, not limited to such low-molecular rod-shaped liquid crystalline compounds, also usable herein are high-molecular rod-shaped liquid crystal compounds.

In the optically anisotropic layer, the rod-shaped liquid crystalline molecules are preferably fixed as aligned therein; and most preferably, they are fixed through polymerization. Examples of the polymerizing rod-shaped liquid crystalline compound usable in the invention are described, for example, in Macromol. Chem., Vol. 190, page 2255 (1989); Advanced materials, Vol. 5, page 107 (1993); U.S. Pat. No. 4,683,327, U.S. Pat. No. 5,622,648, U.S. Pat. No. 5,770,107; WO95/22586, WO95/24455, WO97/00600, WO98/23580, WO98/52905; JP-A-1-272551, JP-A-6-16616, JP-A-7-110469, JP-A-11-80081 and JP-A-2001-328973.

The rod-shaped liquid crystal compound can be used for the optically anisotropic layer of the liquid crystal composition.

In the embodiments where a rod-shaped liquid crystal compound is used and in order that the optically anisotropic layer of the liquid crystal composition can satisfy the necessary characteristics, preferably, at least two different types of rod-shaped liquid crystal compounds are used. Preferred examples of the combination include the combination of at least one rod-shaped liquid crystal of the following formula (4) and at least one rod-shaped liquid crystal of the following formula (5):

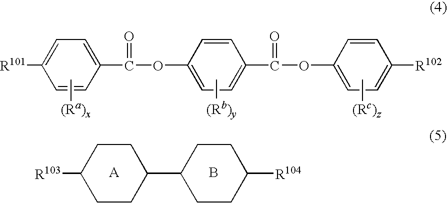

In the formulae, A and B each represent a group of an aromatic or aliphatic hydrocarbon ring or a hetero ring; R¹⁰¹ to R¹⁰⁴ each represent a substituted or non-substituted, C₁₋₁₂ (preferably C₃₋₇) alkylene group, or C₁₋₁₂ (preferably C₃₋₇) alkylene chain-having alkoxy, acyloxy, alkoxycarbonyl or alkoxycarbonyloxy group; R^{a}*, R^{b} and R^{c} each represent a substituent; x, y and z each indicate an integer of from 1 to 4.

In the formulae, the alkyl chain in R¹⁰¹ to R¹⁰⁴ may be either linear or branched. Preferably, it is linear. For curing the composition, R¹⁰¹ to R¹⁰⁴ preferably have a terminal polymerizing group; and examples of the polymerizing group include an acryloyl group, a methacryloyl group and an epoxy group.

In formula (4), preferably, x and z are 0 and y is 1; and one R^{b} is preferably a meta- or ortho-substituent to the oxycarbonyl group or the acyloxy group. R^{b} is preferably a C₁₋₁₂ alkyl group (e.g., methyl group) or a halogen atom (e.g., fluorine atom).

In formula (5), preferably, A and B each are a phenylene group or a cyclohexylene group; and more preferably, A and B are both phenylene groups, or one of them is a cyclohexylene group and the other is a phenylene group.

### <<Production Method for Retardation Film>>

The production method for retardation film preferably includes a step of providing a film for an alignment film on the surface of the cellulose acylate film after the above-mentioned second stretching step, rubbing it to form an alignment film thereon. The alignment film has the function of aligning the liquid crystal compound molecules for use in the invention in a predetermined direction. Accordingly, the alignment film is preferably used in the retardation film.

### [Production of the Support]

### (Surface Treatment of the Cellulose Acylate Film]

The surface treatment is preferably carried out on the cellulose acylate film.

The surface treatment of a cellulose acylate film is sometimes effective for providing an improved adhesion between it and any functional layer (for example, an undercoat or backup layer). The surface treatment includes glow discharge treatment, ultraviolet irradiation, corona treatment, flame treatment and saponifying treatment (such as acid or alkali treatment), particularly preferably the glow discharge treatment and the alkali saponifying treatment. “Glow discharge treatment” is a treatment which plasma treatment is carried out on the surface of the film under plasma-excitable gas. Details thereof are stated in Published Technical Report of The Hatsumei Kyokai (Association of Inventions) (Kokai Gifo of Japan Institute of Invention & Innovation, Kogi No. 2001-1795, published on Mar. 15, 2001).

An undercoat layer (adhesion layer) is preferably formed on the cellulose acylate film for improving adhesion between the film surface and a functional layer as described in JP-A-H7-333433. The undercoat layer may be formed after the above surface treatment or without any surface treatment. For details of the undercoat layer which can be used, reference is made to Published Technical Report of The Hatsumei Kyokai (Association of Inventions) (Report No. 2001-1745, published on Mar. 15, 2001 by Hatsumei Kyokai), page 32. The functional layers on the cellulose acylate film are described in detail in Kokai Gifo of Japan Institute of Invention & Innovation, Kogi No. 2001-1745, published on Mar. 15, 2001, pages 32 to 45.

In view of keeping flatness of the film, temperature of the cellulose acylate film during these processes may preferably be adjusted to Tg (glass transition temperature) or below, and more specifically 150° C. or below.

For the case where the cellulose acylate film is used as a transparent protective film of the polarizer, it is particularly preferable to subject the film to acid treatment or alkali treatment, or saponification of cellulose acylate, from the viewpoint of adhesiveness with the polarizing film. The surface treatment will be described in details below, referring to alkali saponification.

The alkali saponification treatment of the cellulose acylate film may preferably be carried out according to a cycle in which the film is immersed into an alkali solution, neutralized with an acidic solution, washed with water, and then dried.

Examples of the alkali solution include potassium hydroxide solution and sodium hydroxide solution, wherein normality of hydroxyl ion preferably falls in the range from 0.1 to 3.0 N, and more preferably from 0.5 to 2.0 N. Temperature of the alkali solution may preferably fall within the range from room temperature to 90° C., and more preferably from 40 to 70° C.

The surface energy of the cellulose acylate film after the surface treatment may preferably be 55 mN/m or larger, and more preferably 60 mN/m or larger and 75 mN/m or smaller.

Surface energy of solid may be determined by contact angle method, wet heating method, and absorption method, as described in “Nure no Kiso to O-yo (Basics and Applications of Wetting)” (published on Dec. 10, 1989 by Realize)'. The contact angle method may preferably be applicable to the cellulose acylate film in the present invention.

More specifically, two solutions having known values of surface energy are dropped on the cellulose acylate film, wherein the contact angle is defined, at an intersection of the surface of the droplet and the surface of the film, as one of angles formed between a tangential line drawn to the droplet and the surface of the film, and containing the droplet, and the surface energy of the film may be estimated by calculation.

### (Formation of Alignment Film)

The alignment film has a function capable of controlling the alignment direction of liquid crystalline molecules. The alignment film may be provided by techniques such as rubbing of organic compound (preferably polymer), oblique vacuum evaporation of inorganic compound, formation of layer having micro-grooves, accumulation of organic compound (for example, co-tricosanoic acid, dioctadecylmethyl ammonium chloride, methyl stearate) by the Langmuir-Blodgett method. There is also known an alignment film expressing an alignment function when applied with magnetic field or irradiation of light. In the producing method of the cellulose acylate film of the invention, the alignment film is formed by rubbing of a polymer.

The alignment film is formed by rubbing. Polyvinyl alcohol is a preferable polymer. Modified polyvinyl alcohol having hydrophobic groups bound thereto is especially preferable.

Although the alignment film may be composed of only a single species of polymer, the film may more preferably be formed by rubbing a layer composed of two species of polymers crosslinked with each other. As at least one species of polymer, either of a polymer intrinsically crosslinkable per se, or a polymer crosslinkable by a crosslinking agent may preferably used. The alignment film may be formed by allowing a polymer, having a functional group originally or introduced later, to react with each other with the aid of light, heat, pH change and so forth; or by introducing a linking group derived from a crosslinking agent, which is a highly reactive compound, between the polymer chains, to thereby crosslink the polymer.

Such crosslinking may be carried out by coating a coating liquid containing the above-described polymer, or a mixture of such polymer and a crosslinking agent, onto the cellulose acylate film after the high vaporization crystallization treatment, and then by heating the coated solution. The crosslinking may be carried out at any time over the period from coating of the alignment film onto the cellulose acylate film up to acquisition of the optical compensation sheet, so far as a desirable level of durability of the end product (such as optical compensation sheet) may be ensured.

Taking alignment property of the layer (optically anisotropic film) composed of the liquid crystalline compound formed on the alignment film into consideration, it is also preferable to thoroughly proceed crosslinking after the liquid crystalline compound is aligned.

The crosslinking of the alignment film is carried out generally by applying a coating liquid for forming the alignment film to the surface of the cellulose acylate film after the high vaporization crystallization treatment, followed by drying under heating. It is preferable to adjust the temperature of heating of the coating liquid at this stage relatively low, and to allow the crosslinking of the alignment film to thoroughly proceed in the process of high vaporization crystallization for forming the optically anisotropic film described later.

Polymer adoptable to the alignment film may be either of a polymer intrinsically crosslinkable per se, or a polymer crosslinkable by a crosslinking agent. Of course, some polymers are known to afford the both. Examples of the polymer include polymers such as polymethyl methacrylate, acrylate/methacrylate copolymer, styrene/maleimide copolymer, polyvinyl alcohol and modified polyvinyl alcohol, poly (N-methylol acrylamide), styrene/vinyltoluene copolymer, chlorosulfonated polyethylene, nitrocellulose, polyvinyl choloride, chlorinated polyolefin, polyester, polyimide, vinyl acetate/vinyl chloride copolymer, ethylene/vinyl acetate copolymer, carboxymethyl cellulose, polyethylene, polypropyrene, and polycarbonate; and other compounds such as gelatin and silane coupling agent.

Examples of preferable polymer include water-soluble polymers such as poly (N-methylol acrylamide), carboxymethyl cellulose, gelatin, polyvinyl alcohol and modified polyvinyl alcohol. Gelatin, polyvinyl alcohol and modified polyvinyl alcohol may preferably be used, and polyvinyl alcohol and modified polyvinyl alcohol may more preferably be used.

Alternatively, combined use of two or more types of polyvinyl alcohol or modified polyvinyl alcohol differing from each other in the degree of polymerization may be most preferable.

Examples of the polyvinyl alcohol include those having the degree of saponification in the range from 70 to 100%. The degree of saponification generally falls in the range from 80 to 100%, and more preferably falls in the range from 85 to 95%. The degree of polymerization of the polyvinyl alcohol preferably falls in the range from 100 to 3000.

Examples of the modified polyvinyl alcohol include those modified by copolymerization, chain transfer, or block polymerization. Examples of modifier group involved in the modification by copolymerization include COONa, Si(OH)₃, N(CH₃)₃.Cl, C₉H₁₉COO, SO₃, Na and C₁₂H₂₅. Examples of modifier group involved in the modification by chain transfer include COONa, SH and C₁₂H₂₅. Examples of modifier group involved in the modification by block polymerization include COOH, CONH₂ and C₆H₅.

Among these, unmodified or modified polyvinyl alcohols having the degree of saponification in the range from 80 to 100% may be preferable. Unmodified or modified polyvinyl alcohols having the degree of saponification in the range from 85 to 95% may be more preferable.

As the modified polyvinyl alcohol, those modified particularly by the compounds expressed by the formula (6) below may be preferable. Such modified polyvinyl alcohol will be referred to as “specific modified polyvinyl alcohol”, hereinafter.

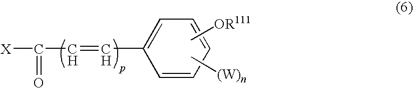

In the formula (6), R¹¹¹ represents an alkyl group, acryloylalkyl group, methacryloylalkyl group, or epoxy alkyl group; W represents a halogen atom, alkyl group, or alkoxy group; X represents an activated ester, acid anhydride, or atomic group necessary for forming acid halide; p represents 0 or 1; and n represents an integer from 0 to 4.

The specific modified polyvinyl alcohol may preferably be those modified by the compound expressed by the formula (7):

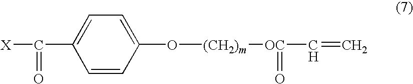

In the formula, X¹ represents an activated ester, acid anhydride, or atomic group necessary for forming acid halide, and m represents an integer from 2 to 24.

Polyvinyl alcohol allowed to react with the compounds expressed by these formulae include the above-described unmodified polyvinyl alcohol, and polyvinyl alcohol modified by copolymerization such as those modified by chain transfer, and block polymerization. Preferable examples of the specific modified polyvinyl alcohol are detailed in JP-A No. H09-152509.

Methods of synthesizing these polymers, visible absorption spectrometry, and method of determining the degree of introduction of the modifier groups are detailed in Japanese JP-A No. H08-338913.

Examples of the crosslinking agent include aldehydes, N-methylol compounds, dioxane derivatives, compounds turned operable after being activated in the carboxyl groups, activated vinyl compounds, activated halogen compounds, isoxazoles, and dialdehyde starch. Examples of the aldehydes include formaldehyde, glyoxal, and glutaraldehyde. Examples of the N-methylol compounds include dimethylol urea and methylol dimethyl hydantoin. Examples of the dioxane derivatives include 2,3-dihydroxydioxane. Examples of the compounds turned operable after being activated in the carboxyl groups include carbenium, 2-naphthalene sulfonate, 1,1-bispyrrolidino-1-chloropyridinium, and 1-morpholinocarbonyl-3-(sulfonatoaminomethyl). Examples of the activated vinyl compounds include 1,3,5-triacroyl-hexahydro-s-triazine, bis (vinylsulfone) methane, and N,N′-methylenebis-[β-(vinylsulfonyl) propionamide]. Examples of the activated halogen compounds include 2,4-dichloro-6-hydroxy-s-triazine. These compounds may be used independently or in combination. These compounds are particularly preferable for the case where they are used together with the above-described, water-soluble polymers, especially polyvinyl alcohol and modified polyvinyl alcohol (including the above-described specific modified products).

Taking productivity into consideration, use of aldehydes having high reactivity, especially glutaraldehyde, is preferable.

There is an improving tendency of moisture proofness (high moisture proofness) of the alignment film, as the amount of addition of the crosslinking agent increases. However, addition of the crosslinking agent to as much as exceeding 50% by mass of the polymer may degrade the aligning performance as the alignment film. The amount of addition of the crosslinking agent relative to the polymer preferably falls in the range from 0.1 to 20% by mass, and more preferably from 0.5 to 15% by mass. The alignment film contains unreacted crosslinking agent to some extent even after completion of the crosslinking reaction, wherein the amount of residual crosslinking agent may preferably be 1.0% by mass of below in the alignment film, and more preferably 0.5% by mass or below. If the amount of unreacted crosslinking agent remained in the alignment film is suppressed within the above-described range, the liquid crystal display device using the film may be no more causative of reticulation, and thereby a sufficient level of durability may desirably be obtained, even after use over a long period, or after being allowed to stand under an atmosphere of high temperature and high humidity over a long period.

For the case where a water-soluble polymer such as polyvinyl alcohol is used as a material for forming the alignment film, solvent for preparing the coating liquid may preferably be organic solvents expressing defoaming action such as methanol, or a mixed solvent of organic solvent and water. For the case where methanol is used as the organic solvent, ratio on the mass basis, expressed as water:methanol, is generally 0:100 to 99:1, and more preferably 0:100 to 91:9. Accordingly, foaming may be suppressed, and surface defects of the alignment film, and also of the optically anisotropic film, may distinctively be reduced.

Methods of coating may be exemplified by spin coating, dip coating, curtain coating, extrusion coating, bar coating and E-type coating. Among these, E-type coating is particularly preferable.

Thickness of the alignment film formed may preferably fall in the range from 0.1 to 10 μm.

Further, it is preferable that a drying under heating is carried out and the drying under heating may be carried out, for example, in a temperature range of 20 to 110° C. In view of forming crosslinkage to a satisfiable degree, the temperature of heating may preferably fall in the range from 60 to 100° C., and more preferably from 80 to 100° C.

The drying may be carried out for 1 minute to 36 hours, and preferably 5 to 30 minutes. Also pH may preferably be adjusted to a value optimum to a crosslinking agent to be adopted. For an exemplary case of using glutaraldehyde, pH may preferably fall in the range from 4.5 to 5.5, and particularly preferably falls on 5.

### (Rubbing Treatment)

As the aforementioned rubbing treatment, the treatment methods widely used for a step of orientating liquid crystals of LCD can be adopted. That is, a method of rubbing a surface of an alignment layer along a certain direction with paper, gauze, felt, rubber, nylon, polyester fibers or the like to obtain orientation is employed. In general, the rubbing treatment is performed by rubbing the surface several times with cloth to which fibers having the same length and the same diameter are evenly transplanted. Preferably a rubbing roller can be used and all of the roundness, cylindricality and deflection (eccentricity) of the rubbing roller are preferably 30 μm or less. The wrapping angle of the film with respect to the rubbing roller is preferably 0.1 to 90°. However, as disclosed in JP-A No. H8-160430, a stable rubbing treatment may be performed by winding a film around the roller for 360° or more. Heretofore, when the retardation is enhanced through high vaporization crystallization treatment, the cellulose acylate film after the treatment becomes brittle with the result that the film often produces rubbing dust in rubbing treatment thereof. However, in the cellulose acylate film production method of the invention, a polymer additive material is added to the cellulose acylate film and therefore the film can exhibit the retardation not becoming brittle even after the high vaporization crystallization treatment, and accordingly, the film produces little cutting dust in rubbing treatment thereof.

Preferably, the film is rubbed with a rubbing roller. The diameter of the rubbing roller to be used in the invention is preferably from 100 to 500 mm, from the viewpoint of the handling aptitude and the cloth life, more preferably from 200 to 400 mm. The width of the rubbing roller must be broader than the width of the film to be conveyed, and is preferably at least the film width×2^{1/2}. The revolution speed of the rubbing roller is preferably set low from the viewpoint of preventing dusting; and depending on the alignment of the liquid crystal compound, it is preferably from 100 to 1,000 rpm, more preferably from 250 to 850 rpm.

In order to keep the alignment of the liquid crystal compound even though the revolution speed of the rubbing roller is set low, it is desirable to heat the support (the cellulose acylate film) or the alignment film during rubbing. The heating temperature in the rubbing is preferably from (Tg of the film material−50° C.) to (Tg of the film material+50° C.), in terms of the film surface temperature of the cellulose acylate film or the alignment film. In case where an alignment film of polyvinyl alcohol is used, it is desirable to control the ambient humidity in rubbing. Preferably, the relative humidity at 25° C. is from 25 to 70% RH, more preferably from 30 to 60% RH, even more preferably from 35 to 55% RH.

The optically anisotropic layer formed of a liquid crystal composition to constitute the cellulose acylate film is characterized in that its Re(550) is from 20 to 100 nm and it contains a liquid crystal. One example of the optically anisotropic layer having such characteristics is an optically anisotropic layer formed by fixing a liquid crystal composition in a hybrid alignment state. Among the characteristics of containing a liquid crystal, more preferably, the preferred characteristic of the optically anisotropic layer comprising a liquid crystal composition is that the layer does not have a direction in which its Re(550) is 0 nm and the direction in which the absolute value of Re (550) of the layer is the smallest is neither in the normal line direction of the layer nor in the plane of the layer. Preferably, the optically anisotropic layer is formed by fixing a discotic liquid crystal composition in a hybrid alignment state on the alignment film after the alignment treatment of the cellulose acylate film.

Specifically, it is desirable that the optically anisotropic layer comprising a liquid crystal composition contains a discotic liquid crystal compound from the viewpoint of compensation for liquid crystal cell.

When Re(550) of the optically anisotropic layer comprising a liquid crystal composition is at least 20 nm, then the layer can fully secure the optical compensation capability heretofore attained for conventional cellulose acylate film constitution. In case where Re(550) is at most 100 nm or where the film does not have a direction in which its Re(550) could be 0 nm or where the direction in which the absolute value of Re(550) is the smallest does not exist in the normal line direction or in the plane, the film may fully attain optical compensation for the liquid crystal in the cell in hybrid alignment, and favorably, therefore, the contrast viewing angle is broadened and the film is resistant to coloration.

Re(550) of the optically anisotropic layer formed of a liquid crystal composition is more preferably from 20 to 40 nm, even more preferably from 25 to 40 nm.

### [Step of Forming Optically Anisotropic Layer of Liquid Crystal Composition]

The retardation film production method includes a step of forming an optically anisotropic layer of a liquid crystal composition on the surface of the cellulose acylate film on the side thereof on which the alignment film is formed. The optically anisotropic layer of a liquid crystal composition is formed on the cellulose acylate film on the side thereof on which the alignment film is formed. Preferably, the optically anisotropic layer of the liquid crystal composition is prepared as follows. A composition for the optically anisotropic layer of the liquid crystal containing at least one type of a liquid crystal compound is disposed on the surface of the cellulose acylate film on which the alignment film is disposed; and then the molecules of the liquid crystal compound are aligned in a desired alignment state. The polymerization and curing is carried out thereby fix the alignment state. In order that the optically anisotropic layer of the liquid crystal composition satisfies the characteristics that it does not have a direction in which its Re(550) is 0 nm and that the direction in which the absolute value of its Re(550) is the smallest is neither in the normal line direction of the layer nor in the in-plane direction thereof, the molecules of the liquid crystal compound (including both rod-shaped and discotic molecules) are preferably fixed in a hybrid alignment state. The hybrid alignment means that the direction of the director of the liquid crystal molecules continuously changes in the thickness direction of the layer. In rod-shaped molecules, the director is in the direction of the major axis thereof; and in discotic molecules, the director is in the normal line direction of the discotic face thereof.

In order that the molecules of a liquid crystal compound are aligned in a desired alignment state, and for the purpose of bettering the coating applicability and the curability of the composition, the composition may contain one or more additives.

For hybrid alignment of the molecules of a liquid crystal compound (especially a rod-shaped liquid crystal compound), an additive for controlling the alignment on the air interface side of the layer (hereinafter this may be referred to as “air-interface alignment controlling agent”) may be added. The additive includes a low-molecular-weight or high-molecular-weight compounds having a hydrophilic group such as a fluoroalkyl group or a sulfonyl group. Specific examples of the air-interface alignment controlling agent usable herein are described in JPA No. 2006-267171.

When the composition is prepared as a coating liquid and the optically anisotropic layer of the liquid crystal composition is formed by coating with it, a surfactant may be added thereto for bettering the coating applicability of the liquid. As the surfactant, preferred is a fluorine compound concretely including, for example, the compounds described in JPA No. 2001-330725, paragraphs [0028] to [0056]. Also usable is a commercial product, Megafac F780 (by Dai-Nippon Ink).

Preferably, the coating composition contains a polymerization initiator. The polymerization initiator may be either a thermal polymerization initiator or a photopolymerization initiator; but preferred is a photopolymerization initiator as it is easy to control. Examples of the photo-polymerization initiator capable of generating radicals under irradiation with light include α-carbonyl compounds (those described in U.S. Pat. Nos. 2,367,661 and 2,367,670), acyloin ethers (those described in U.S. Pat. No. 2,448,828), α-hydrocarbon-substituted aromatic acyloin compounds (those described in U.S. Pat. No. 2,722,512), polynuclear quinone compounds (those described in U.S. Pat. Nos. 3,046,127 and 2,951,758), combinations of triarylimidazole dimer and p-aminophenyl ketone (those described in U.S. Pat. No. 3,549,367), acrydine and phenazine compounds (those described in JPA No. S60-105667 and U.S. Pat. No. 4,239,850), oxadiazole compounds (those described in U.S. Pat. No. 4,212,970), acetophenone-type compounds, benzoin ether-type compounds, benzyl-type compounds, benzophenone-type compounds and thioxanthone-type compounds. Examples of the acetophenone-type compound include 2,2-diethoxy acetophenone, 2-hydroxymethyl-1-phenylpropane-1-on, 4′-isopropyl-2-hydroxy-2-methyl-propiophenone, 2-hydroxy-2-methyl-propiophenone, p-dimethylamino acetone, p-tert-butyl dichloro acetophenone, p-tert-butyl trichloro acetophenone, and p-azidebenzal acetophenone. Examples of the benzyl-type compound include benzyl, benzyl dimethyl ketal, benzyl-β-methoxy ethyl acetal and 1-hydroxy cyclohexyl phenyl ketone. Examples of the benzoin ether compound include benzoin, benzoin methyl ether, benzoin ethyl ether, benzoin-n-propyl ether, benzoin isopropyl ether, benzoin-n-butyl ether, and benzoin isobutyl ether. Examples of the benzophenone-type compound include benzophenone, o-benzoyl methyl benzoate, 4,4′-bis diethylamino benzophenone and 4,4′-dichloro benzophenone. Examples of the thioxanthone-type compound include thioxanthone, 2-methyl thioxanthone, 2-ethyl thioxanthone, 2-isppropyl thioxanthone, 4-isopropyl thioxanthone, 2-chloro thioxanthone and 2,4-diethyl thioxanthone. Among the aromatic ketones functioning as a photo-sensitive radical polymerization initiator, acetophenone-type compounds and benzyl-type compounds are preferable, in terms of hardening properties, preservation stabilities, and odor. One or more selected from these photo-sensitive radical polymerization initiators may be used depending on the desirable properties.

For the purpose of enhancing the effect, one or more sensitizers may be used in addition to the polymerization initiator. Examples of the sensitizer include n-butyl amine, triethyl amine, tri-n-butyl phosphine and thioxanthone.

Two or more polymerization initiators may be used in combination. The amount of the polymerization initiator in the coating liquid is preferably from 0.01 to 20% by mass, and more preferably from 0.5 to 5% by mass, with respect to the solid content of the coating liquid. Light-irradiation for polymerization of the liquid crystal compound is preferably carried out with UV-light.

The composition may further comprise at least one non-liquid crystal polymerizable monomer along with the polymerizable liquid crystal compound. Examples of the polymerizable monomer include any compounds having a vinyl, vinyloxy, acryloyl or methacryloyl. Poly-functional monomers, having two or more polymerizable groups in a molecule, such as ethylene oxide-modified trimethylol propane acrylate are preferable in terms of durability.

The amount of the non-liquid crystal polymerizable monomer is less than 15% around by mass, more preferably from 0 to 10% around by mass, with respect to the amount of the liquid crystal compound.

The optically anisotropic layer of the liquid crystal composition may be prepared as follows. The composition is prepared as a coating liquid. The coating liquid is applied to a surface of an alignment layer formed on the alignment film disposed surface of the cellulose acylate film which is used as a support, and dried to remove the solvent therefrom. Then, the molecules of the liquid crystal compound are aligned in a desired state. The polymerization and curing is carried out to fix the alignment. A polymer for the alignment film usable can be the polymer exemplified in forming it, for example, polyvinylalcohol and polyimide can be used. In this way, the optically anisotropic layer of the liquid crystal composition is prepared.

Any coating methods may be employed for applying the coating liquid to a surface. Examples of the coating method include a curtain coating method, a dip coating method, a spin-coating method, a printing coating method, a spray coating method, a slot coating method, a roll coating method, a slide coating method, a blade coating method, a gravure coating method and a wire-bar coating method.

Drying of the layer may be carried out under heat. When the solvent in the layer is removed from the layer by drying, the molecules of the liquid crystal compound are aligned. Then, the desired alignment state is obtained.

Next, polymerization is carried out with irradiation of UV-light and the alignment is fixed. In this way, the first optically anisotropic layer is prepared. The irradiation energy is preferably 20 mJ/cm² to 50 J/cm², more preferably 100 to 800 mJ/cm². Irradiation may be carried out under heat to accelerate the photo-polymerization reaction.

### <<Polarizer>>

The cellulose acylate film can also be applied to a polarizer comprising the cellulose acylate film and a polarizing film. When the polarizer is incorporated into a liquid crystal display device, preferably, the polarizer is so disposed in the device that the cellulose acylate film thereof is on the side of the liquid crystal cell in the device. Also preferably, the surface of cellulose acylate film is stuck to the surface of the polarizing film; and preferably, the in-plane slow axis of the cellulose acylate film crosses the transmission axis of the polarizing film at an angle of 0 degree. The crossing angle may not always be 0 degree strictly, and an error of ±5 degrees acceptable in production does not have any influence on the effect of the invention, and is therefore acceptable in the invention. Also preferably, a protective film such as a cellulose acylate film is stuck to the other surface of the polarizing film.

### [Structure of Polarizer]

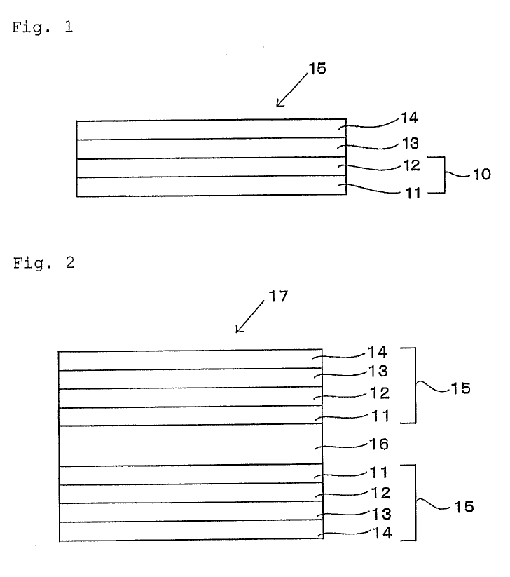

FIG. 1 shows a schematic cross-sectional view of one embodiment of a polarizer. The polarizer 15 shown in FIG. 1 comprises a polarizing film 13, and has, on its surfaces, a retardation film 10 and a protective film 14 that protect the polarizing film 13. The retardation film 10 is formed of the cellulose acylate film 12 and its back, which is the optically anisotropic layer of the liquid crystal composition 11; that is, The retardation film 10's face not coated with the optically anisotropic layer 11 is stuck to the surface of the polarizing film 13. In case where the polarizer 15 is incorporated into a liquid crystal display device, the retardation film 10 is disposed on the side of the liquid crystal cell in the device. Though not shown in the drawing, the polarizer 15 of FIG. 1 may have any other functional layer, and for example, a diffusion layer, an antiglare layer and others may be disposed outside the protective film 14.

Various materials usable in fabricating the polarizer are described below.

### (Polarizing Film)

Examples of a polarizing film include an iodine-base polarizing film, a dye-base polarizing film with a dichroic dye, and a polyene-base polarizing film, and any of these is usable in the invention. The iodine-base polarizing film and the dye-base polarizing film are produced generally by the use of polyvinyl alcohol films.

### (Protective Film)

As the protective film to be stuck to the other surface of the polarizing film, preferably used is a transparent polymer film. “Transparent” means that the film has a light transmittance of at least 80%. As the protective film, preferred are cellulose acylate films and polyolefin films. Of cellulose acylate films, preferred are cellulose triacetate film. Of polyolefin films, preferred are cyclic polyolefin-containing polynorbornene films.

Preferably, the thickness of the protective film is from 20 to 500 μm, more preferably from 50 to 200 μm.

### (Light Diffusion Film)

The polarizer may have a light diffusion film on one surface of the polarizing film. The light diffusion film may be a single-layer film or a laminate film. One example of an embodiment of the laminate film comprises a light diffusion film having a light-scattering layer formed on a light-transmitting polymer film. The light diffusion film contributes toward broadening the viewing angle when the viewing angle is inclined in the vertical direction and in the horizontal direction, and in an embodiment where an antireflection film is arranged outside the polarizer on the panel side, the light diffusion film exhibits an especially high effect. The light diffusion film or its light scattering layer may be formed of a composition of fine particles dispersed in a binder. The fine particles may be inorganic particles or organic particles. Preferably, the difference in the refractive index between the binder and the fine particles is from 0.02 to 0.20 or so. The light diffusion film or its light scattering layer may additionally have a hard coat function. Regarding the light diffusion film usable in the invention, referred to are JP-A-11-38208 where a light scattering coefficient is specifically defined; JP-A-2000-199809 where the relative refractive index of transparent resin and fine particles is specifically defined to fall within a specific range; and JP-A-2002-107512 where the haze value is defined to be at least 40%.

### (Hard Coat Film, Antiglare Film, Antireflection Film)

As the case may be, the cellulose acylate film may be applied to a hard coat film, an antiglare film and an antireflection film. For the purpose of improving the visibility of flat panel displays such as LCD, PDP, CRT, EL, any or all of a hard coat layer, an antiglare layer and an antireflection layer may be given to one or both surfaces of the cellulose acylate film. Preferred embodiments of such antiglare film and antireflection film are described in detail in Hatsumei Kyokai Disclosure Bulletin (No. 2001-1745, issued Mar. 15, 2001, Hatsumei Kyokai), pp. 54-57, and are preferably employed also for the cellulose acylate film.

### [Method for Producing a Polarizer]

The polarizer can be produced in the shape of a long-size polarizer. For example, the cellulose acylate film is used and on its surface, a coating liquid for alignment film formation is optionally applied to form an alignment film thereon, and subsequently, a coating liquid for the optically anisotropic layer of the liquid crystal composition formation is continuously applied onto it and dried to make the coating film have a desired alignment state, and thereafter through irradiation with light, the alignment state is fixed to form the optically anisotropic layer of the liquid crystal composition. In that manner, the retardation film the shape of which is long-size is fabricated, and this can be wound up as a roll. Separately, a roll of a long-size polarizing film and a roll of a long-size polymer film for protective film are prepared and, while unrolled, they are stuck together according to a roll-to-roll method to fabricate a long-size polarizer. The long-size polarizer may be, for example, wound up as a roll and may be transported or stored; and before it is incorporated into a liquid crystal display device, it may be cut into a desired size. The shape of the polarizer is not limited to the long-size and the above process is an example of the method for producing a polarizer.

In producing the cellulose acylate film, when it is stretched in the machine direction, then the polarizer may be produced in a roll-to-roll process with the film, and this is favorable for simplifying the polarizer production process and for enhancing the axial alignment accuracy in sticking the polarizing film and the cellulose acylate film.

### <<Liquid Crystal Display Device>>

The cellulose acylate film, the retardation film and the polarizer may be used in various types of liquid crystal display devices, such as a TN-mode liquid crystal display, an IPS-mode liquid crystal display, an ECB-mode liquid crystal display, a STN-mode liquid crystal display, a VA-mode liquid crystal display, an OCB-mode liquid crystal display, a HAN-mode liquid crystal display, and the other mode liquid crystal display (for example, an ASM-mode liquid crystal display having a liquid crystal cell of Axially Symmetric Aligned Microcell mode). Hereinafter describes each liquid crystal cell mode which those films can be used. Above all, the cellulose acylate film, the retardation film and the polarizer are especially preferably used for a TN-mode liquid crystal display device and an IPS-mode liquid crystal display device.

FIG. 2 shows a schematic cross-sectional view of a TN-mode liquid crystal display device. The liquid crystal display device shown in FIG. 2 comprises a TN-mode liquid crystal cell 16, and has two polarizer 15 symmetrically disposed above and below the liquid crystal cell 16 to sandwich it therebetween. The liquid crystal cell 16 has a liquid crystal layer comprising a nematic liquid crystal material, and the liquid crystal layer is so constituted that it is in a twisted alignment state in the absence of driving voltage application thereto and that it is in a vertical alignment state to the substrate face in the presence of driving voltage application thereto.

The upper and lower polarizer 15 are so disposed that the transmission axes of their polarizing films 13 cross perpendicularly to each other; and therefore, in the absence of driving voltage application to the device, the linear polarized light having entered the liquid crystal cell 16 from the backlight (not shown) disposed on the back of the lower polarizer 15 rotates by 90° along the twisted alignment of the liquid crystal layer, then passes through the transmission axis of the upper polarizer 15 to give white state. On the other hand, in the presence of driving voltage application to the device, the linear polarized light having entered the liquid crystal cell 16 keeps its polarization state and directly passes through it as it is, and is therefore blocked by the upper polarizer 15 to give black state. The retardation films 10 disposed above and below the liquid crystal cell 16 compensate the birefringence that occurs in oblique directions in the black state.

### EXAMPLES

The characteristics of the invention are described more concretely with reference to the following Examples. In the following Examples, the material used, its amount and the ratio, the details of the treatment and the treatment process may be suitably modified or changed. Accordingly, the invention should not be limitatively interpreted by the Examples mentioned below.

### <<Measurement Methods>>

Evaluation methods for the properties used in the following Examples are described below.

### (1) Degree of Substitution

The degree of acyl substitution of the cellulose acylate film is determined by ¹³C-NMR according to the method described in Carbohydr. Res., 273 (1995), 83-91 (Tezuka, et al).

### (2) Quantity of Crystallization Heat (ΔHc)

A differential scanning calorimeter (DSC, “DSC8230”, produced by Rigaku Corporation) is used and 5 or 6 mg of the cellulose acylate film is put into a sample pan made of aluminium for DSC, this is heated from 25° C. up to 120° C. at a rate of 20° C./min in a nitrogen stream atmosphere at a rate of 50 ml/min, then kept as such for 15 minutes, and thereafter cooled down to 30° C. at a rate of −20° C./min, and further, this is again heated from 30° C. up to 320° C. at a rate of 20° C./min, and the area surrounded by the exothermic peak appearing in the heat cycle and the base line of the sample is measured. This is the quantity of crystallization heat of the cellulose acylate film.

### Example 1

### (1) Production of Cellulose Acylate Film

### (1-1) Preparation of Dope and Casting

A polymer solution A having the composition mentioned below and containing a plasticizer AA-1 not having a negative intrinsic birefringence (condensate of ethanediol/adipic acid, 1/1 by mol, having a number-average molecular weight of 1000) and a retardation regulating agent BB-1 (compound BB-1 having the structure mentioned below) was heated at 30° C., and then cast onto a mirror-face stainless support of a drum having a diameter of 3 m, through a caster, Giesser. The surface temperature of the support was set at −5° C., and the coating width was 200 cm. The space temperature in the entire casting zone was set at 15° C.

Composition of Polymer Solution A

| | | |
|---|---|---|
| Cellulose acetate having a mean degree of | 100.0 | mas. pts. |
| substitution of 2.94 | | |
| Methylene chloride (first solvent) | 475.9 | mas. pts. |
| Methanol (second solvent) | 113.0 | mas. pts. |
| Butanol (third solvent) | 5.9 | mas. pts. |
| Silica particles having a mean particle size | 0.13 | mas. pts. |
| of 16 nm (AEROSIL R972, by Nippon Aerosil) | | |
| Plasticizer not having negative intrinsic | 15.0 | mas. pts. |
| birefringence (AA-1 mentioned above) | | |
| Wavelength dispersion regulating agent | 1.0 | mas. pt. |
| (compound BB-1 mentioned below) | | |
| Citrate | 0.01 | mas. pts. |

Compound BB-1:

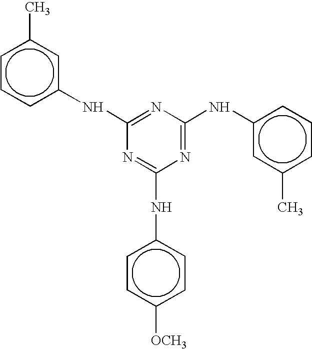

### (1-2) First Stretching Step:

At 50 cm before the end point of the casting zone, the cellulose acylate film (web) thus cast and rotated was peeled off from the drum while having a residual solvent amount of 270%, conveyed by a pin tenter and stretched by 40% in the machinen direction. The residual solvent amount in the web peeled off from the drum is the residual solvent amount at the start of the first stretching step, and is shown in Table 2 below. The residual solvent amount in this stage was determined by sampling a part of the web peeled off from the drum, and computing its mass change before and after drying at 120° C. for 2 hours according to the above-mentioned method.

The draw ratio (%) in stretching the web in the first stretching step was derived from the ratio of the drum speed to the tenter speed. The stretching temperature (web surface temperature) was kept at −5° C. by controlling the drum temperature with a coolant. The drawing speed was 1000%/min.

### (1-3) Drying Step, Second Stretching Step:

After the first stretching step, a part of the web before dried was sampled, and the residual solvent amount therein was determined by computing the mass change before and after drying at 120° C. for 2 hours according to the above-mentioned method. The residual solvent amount in this stage is the residual solvent amount at the start of the drying step, and is shown in Table 2 below. In Example 1, the residual solvent amount at the end of the first stretching step was nearly on the level mentioned above, and therefore, any additional step of specifically controlling the residual solvent amount was not taken after the end of the first stretching step and before the start of the drying step. In the other Examples and Comparative Examples, the sample was suitably dried so that the web surface temperature could not reach 50° C. to thereby control the residual solvent amount therein.

Next, the sampel was dried in the drying (crystallization treatment) step at a drying temperature (web surface temperautre) of 80° C.; and when the residual solvent amount therein reached 7%, the sample was then conveyed by a ten pinter for the second stretching step. The drying temperature was controlled by controlling the temperature in the stretching zone with dry air.

Next, the residual solvent amount in the resulting film before the start of the second stretching step was determined by sampling a part of the film in the drying zone and computing the mass change before and after drying at 120° C. for 2 hours according to the above-mentioned method, and this is shown in Table 2 below. Next, using a pin tenter, the film was stretched at 135° C. by 4% in the direction perpendicular to the machine direction. The stretching temperature (film surface temperature) controlled by applying dry air to the film being stretched. The drawing speed was 60%/min.

The draw ratio (%) in stretching the film in the second stretching step was computed from the change in the pin tenter width at the start of the second stretching step and after the stretching.

### (1-4) Post-Drying Step, Winding:

The film after the second stretching step was dried at 140° C. for 20 minutes.

In that manner, a cellulose acylate film having a width of 1400 mm and a thickness of 73.8 μm was produced, and wound up by a winder.

Thus obtained, the cellulose acylate film had Re=80 nm, Rth=60 nm and Nz=1.25. The value of Re(450)−Re(550), and the value of Rth(450)−Rth(550) were computed through measurement. The heat of fusion of the film ΔHc was determined according to the above-mentioned method. The results are shown in Table 3 below. (In Table 3, the data of Nz are suitably rounded.)

### (2) Formation of Optically Anisotropic Layer of Liquid Crystal Composition

### (2-1) Saponification of Cellulose Acylate Film:

The cellulose acylate film obtained in the above was led to pass through a dielectric heating roll at a temperature of 60° C. so that the film surface temperature was elevated up to 40° C., and then, using a bar coater, an alkali solution having the composition mentioned below was applied to it in an amount of 14 ml/m²; thereafter this was kept staying below a steam-type far-infrared heater (by Noritake Company) heated at 110° C. for 10 seconds, and then also using a bar coater, pure water was applied thereto in an amount of 3 ml/m². In this stage, the film temperature was 40° C. Next, this was washed with water using a fountain coater and treated with an air knife for water removal, repeatedly three times each, and then dried in a drying zone at 70° C. for 2 seconds.

Composition of Alkali Solution for Saponification

| | | |
|---|---|---|
| Potassium hydroxide | 4.7 | mas. pts. |
| Water | 15.7 | mas. pts. |
| Isopropanol | 64.8 | mas. pts. |
| Propylene glycol | 14.9 | mas. pts. |
| Surfactant (C₁₆H₃₃O(CH₂CH₂0)₁₀H) | 1.0 | mas. pt. |

### (2-2) Formation of Alignment Film

On the cellulose acylate film, a coating liquid for alignment film having the formulation mentioned below was applied in an amount of 24 mL/m², using a wire bar coater of #14. This was dried with hot air at 100° C. for 120 seconds. The thickness of the alignment film was 1.2 μm. Next, with the machine direction (MD direction) of the cellulose acylate film regarded as 0°, the coated alignment film formed on it was rubbed with rubbing roller of 2000 mm width at a rate of 400 rounds per minutes in the direction of 0°. The conveying speed was 90 m/min. Then, the subbed surface was subjected to ultrasonic dust removing.

Composition of Coating Liquid for Alignment Film

| | | |
|---|---|---|
| Modified polyvinyl alcohol mentioned below | 40 | mas. pts. |
| Water | 728 | mas. pts. |
| Methanol | 228 | mas. pts. |
| Glutaraldehyde (crosslinking agent) | 2 | mas. pts. |
| Citrate (AS3, by Sankyo Chemical) | 0.69 | mas. pts. |

Modified Polyvinyl Alcohol:

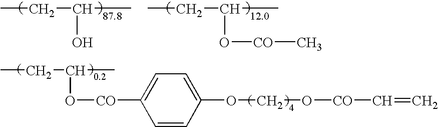

### (2-3) Formation of the Optically Anisotropic Layer

A coating liquid for the optically anisotropic layer having the formulation mentioned below was continuously applied onto the subbed surface of the alignment film with a wire bar. Then the film was heated in the constant temperature bath of 130° C. for 120 seconds, to thereby align the discotic liquid crystal compound. Next, this was irradiated with UV rays by using a high-pressure mercury lamp of which output power was 160 W/cm for 40 seconds at 80° C. to thereby promote the crosslinking reaction to fix the aligned discotic liquid crystal compound. Next, this was left cooled to room temperature.

Re of the thus-formed optically anisotropic layer alone, measured at a wavelength of 550 nm, was 28 nm. The thickness of the optically anisotropic layer alone is shown in Table below. The optically anisotropic layer was analyzed from the normal line direction to 50-degree inclined directions on one side at intervals of 10 degrees, totaling 11 points in all on both sides, by applying a light at a wavelength of 550 nm to each point. The found data of the retardation value, the estimated value of the mean refractive index and the inputted film thickness were processed with KOBRA 21ADH or WR. As a result, it was confirmed that in the first optically anisotropic layer, the molecules of the discotic liquid crystal compound were fixed in a hybrid alignment state, that the layer has no direction in which Re(550) thereof could be 0 nm, and that the direction in which the absolute value of Re(550) of the layer could be the smallest is neither in the normal line direction of the layer nor in the plane thereof.

The obtained film is the film of Example 1.

Composition of Coating Liquid for the Optically Anisotropic Layer

| | |
|---|---|
| Methyl ethyl ketone | 270.0 mas. pts. |
| First discotic liquid crystal compound shown | 90.0 mas. pts. |
| in Table 1 | |
| Second discotic liquid crystal compound shown | 10.0 mas. pts. |
| in Table 1 | |
| Agent for controlling alignment at air-interface | 1.0 mas. pts. |
| shown below | |
| Photopolymerization initiator (Irgacure 907, | 3.0 mas. pts. |
| by Chiba Inc (BASF)) | |
| Sensitizer (Kayacure DETX, by Nippon Kayaku | 1.0 mas. pts. |
| co. ltd) | |

TABLE 1

| Composition of | | Second | |
|---|---|---|---|
| Coating Liquid | | Discotic | |
| for the Optically | First Discotic | Liquid | |
| Anisotropic | Liquid Crystal | Crystal | Thickness |
| Layer | Compound | Compound | [μm] |
| 1 | Compound (1) | Compound (1) | 1.2 |
| 2 | Compound (2) | Compound (2) | 0.9 |
| 3 | Compound (2) | Compound (1) | 1 |
| 4 | Compound (3) | Compound (1) | 1 |
| 5 | Compound (4) | Compound (1) | 1 |
| 6 | Compound (5) | Compound (1) | 1 |
| 7 | Compound (6) | Compound (1) | 1 |
| 8 | Compound (7) | Compound (1) | 1 |

Discotic Liquid Crystal Compound (1) to (8):
(1)

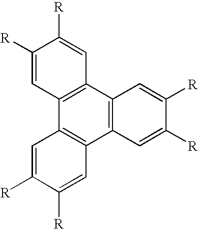

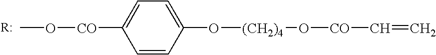

(2)

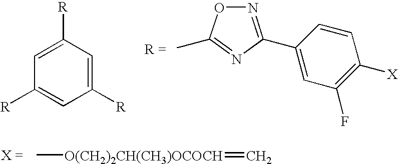

(3)

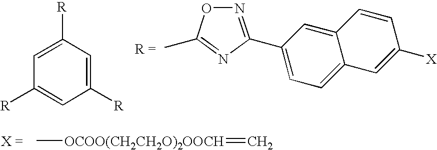

(4)

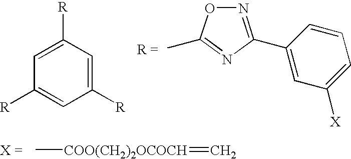

(5)

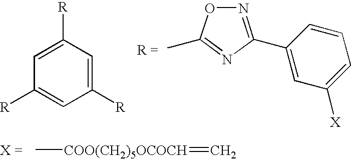

(6)

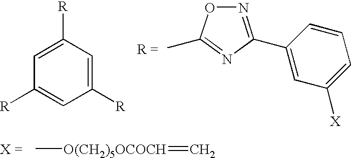

(7)

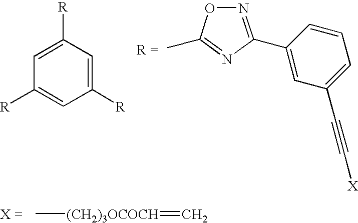

### Agent for Controlling Alignment at Air-Interface:

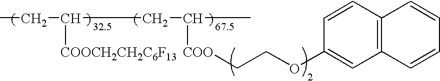

### (3) Fabrication of Polarizer

A polyvinyl alcohol (PVA) film having a thickness of 80 μm was dyed by dipping it in an aqueous iodine solution having an iodine concentration of 0.05% by mass at 30° C. for 60 seconds, and then while dipped in an aqueous boric acid solution having a boric acid concentration of 4% by mass, this was stretched in the machine direction by 5 times the original length, and thereafter dried at 50° C. for 4 minutes to give a polarizing film having a thickness of 20 μm.

The exposed surface of the cellulose acylate film produced in the above (the face thereof not coated with the optically anisotropic layer of the liquid crystal composition-) was dipped in an aqueous sodium hydroxide solution (1.5 mol/L) at 55° C., and then fully washed with water to remove sodium hydroxide. Next, this was dipped in an aqueous diluted sulfuric acid solution (0.005 mol/L) at 35° C. for 1 minute, then dipped in water to fully remove the aqueous diluted sulfuric acid solution. Finally, the sample was fully dried at 120° C.

The optical film saponified in the manner as above was combined with a commercial cellulose acetate film that had been saponified also in the same manner as above, the above-mentioned polarizing film was sandwiched between them, and these were stuck together with a polyvinyl alcohol adhesive so that the saponified surfaces of the films were face each other, thereby fabricating a polarizer. The commercial cellulose acetate film was Fujitac TF80UL (by FUJIFILM Corporation). In this, the polarizing film and the protective film on both surfaces of the polarizing film were produced all as rolls, and therefore, the machine direction of every roll was parallel to each other, and the rolls were unrolled and continuously stuck together. Accordingly, the absorption axis of the polarizer was parallel to the machine direction of the optical film roll (the casting direction in film formation). In this way, a polarizer of Example 1 is fabricated.

### (4) Construction of TN-Mode Liquid Crystal Display Device

A TN-mode liquid crystal display device having the same constitution as in FIG. 2 was constructed. Concretely, in a liquid crystal display device having a TN-mode liquid crystal cell (Nippon Acer's AL2216W), a pair of polarizer were removed, and in place of them, the polarizer fabricated in the above was stuck each one on both the viewers' side and the backlight side, using an adhesive, in such a manner that its optically anisotropic layer could face the side of the liquid crystal cell. In this, the two polarizers were so disposed that the transmission axis of the polarizer on the viewers' side was perpendicular to the transmission axis of the polarizer on the backlight side. In this way, TN-mode liquid crystal display device of Example 1 was constructed.

### Example 2 to 8

Films of Examples 2 to 8 were produced in the same manner as in Example 1, for which, however, the additives and the stretching and drying conditions were changed as in Table 2, and the composition of the optically anisotropic layer was changed as in Table 1 in which the constitutive ingredients are shown in the above Table (liquid crystal composition). The ingredients not shown in Table 1 are the same as those in the composition in Example 1. Using the films of Examples 2 to 8 and in the same manner as in Example 1, polarizers and TN-mode liquid crystal display devices of Examples 2 to 8 were produced.

### Examples 9 to 18, 22 to 24, and 26 to 28

Films, polarizers and liquid crystal display devices of Examples 9 to 18, 22 to 24, and 26 to 28 were produced in the same manner as in Example 1, for which, however, the additives and the stretching and drying conditions were changed as in Table 2. The details of the additives used in Examples are mentioned below.

Plasticizer AA-2: Condensate of ethanediol/phthalic acid (1/1 by mol) terminated with acetic acid (number-average molecular weight, 1000).
Plasticizer AA-3: Condensate of ethanediol/adipic acid/phthalic acid (1/0.5/0.5 by mol) terminated with acetic acid (number-average molecular weight, 5000).
Plasticizer AA-4: Condensate of ethanediol/succinic acid (1/1 by mol) terminated with acetic acid (number-average molecular weight, 10000).
Plasticizer AA-5 (number-average molecular weight, 247), having the following structure:

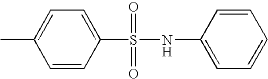

Plasticizer AF-1 having negative intrinsic birefringence: Styrene-maleic anhydride copolymer (weight-average molecular weight, 5500).
Plasticizer AF-2 having negative intrinsic birefringence: p-hydroxystyrene polymer (weight-average molecular weight, 2000).

### Retardation Regulating Agent BB-2:

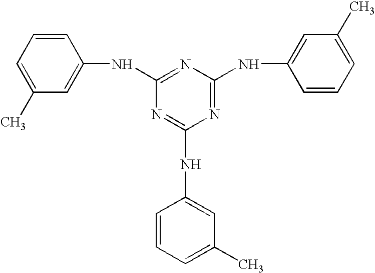

### Wavelength Dispersion Regulating Agent AB-1 (Having Absorption Maximum at 369 nm):

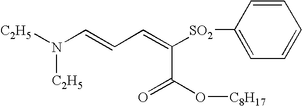

### Wavelength Dispersion Regulating Agent AB-2 (Having Absorption Maximum at 375 nm):

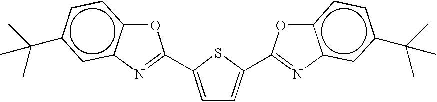

### Compound AB-3 (Having Absorption Maximum at 350 nm):

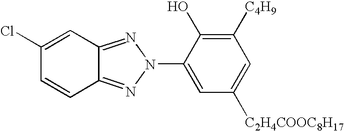

### Example 19

### 1) Rear Polarizer for IPS

A cellulose acylate film and a polarizer of Example 19 were produced in the same manner as in Example 1, for which, however, the additives and the stretching and drying conditions were changed as in Table 2 and the optically anisotropic layer of liquid crystal composition was not formed. The cellulose acylate film of Example 19 was stuck to the polarizer of Example 19 with an adhesive in such a manner that the absorption axis of the polarizer could be perpendicular to the slow axis of the film, thereby producing a retardation film-fitted polarizer of Example 19 having two cellulose acylate films laminated with an adhesive therein.

### 2) Front Polarizer for IPS

A commercial triacetyl cellulose film, Z-TAC (by FUJIFILM) and a commercial triacetyl cellulose film, TD80 (by FUJIFILM) were separately dipped in an aqueous sodium hydroxide solution (concentration, 1.5 mol/L) at 55° C., and then fully rinsed with water to remove sodium hydroxide. Next, These were dipped in an aqueous diluted sulfuric acid (concentration, 0.005 mol/L) at 35° C. for 1 minute, and then dipped in water to fully remove the aqueous diluted sulfuric acid. Finally, this was fully dried at 120° C. to complete the saponification.

The saponified TD80 and the saponified Z-TAC were stuck via a polarizing film sandwiched therebetween, with a polyvinyl alcohol adhesive, thereby producing a front polarizer for IPS.

### 3) Production of IPS Panel

The polarizer on the surface and the back of 37H3000 (by Toshiba) was peeled off, and the retardation film-fitted polarizer of Example 19 mentioned above was stuck to the light source side of the device with an adhesive, in such a manner that the slow axis of the liquid crystal cell could be perpendicular to the absorption axis of the polarizer and that the cellulose acylate film could face the liquid crystal cell, and the front polarizer for IPS was stuck to the other side thereof opposite to the liquid crystal cell with an adhesive in such a manner that the absorption axis thereof could be perpendicular to the absorption axis of the facing rear polarizer and that the Z-TAC side of the front polarizer for IPS could face the liquid crystal cell, thereby constructing an IPS-mode liquid crystal display device.

### Examples 20 and 25

Polarizers and IPS-mode liquid crystal display devices of Examples 20 and 25 were produced in the same manner as in Example 19, for which, however, the dope formulation and the processing steps were changed as in the Table shown below.

### Example 21

A polarizer and an IPS-mode liquid crystal display device of Example 21 were produced in the same manner as in Example 19, for which, however, the dope formulation and the processing steps were changed as in the Table shown below, and in producing the rear polarizer for IPS, the retardation film was not stuck to the polarizer but the retardation film was a single film.

### Comparative Examples 1 to 5

Cellulose acylate films were produced in the same manner as in Example 1, for which, however, the dope formulation and the process conditions were changed as in the Table below; and using the films, polarizers and liquid crystal display devices were produced.

### Test Examples

The cellulose acylate films and the liquid crystal display devices produced in Examples and Comparative Examples were tested and evaluated as follows. The test results are shown in Table 3 below.

### (1) Bleeding:

The cellulose acylate films produced and finished in Examples and Comparative Examples were visually checked for precipitation of ingredients thereon.

### (2) Evaporation:

Using a tester TG/DTA, the additive was heated from room temperature up to 140° C., and kept at 140° C. for 1 hour, and the weight change of the additive was determined. Based on the condition mentioned below, the thus tested additive was evaluated as follows:

When the weight change was at most 0.1%, “no” is given to the additive, and when the weight change was more than it, “yes” is given thereto.

### (3) Viewing Angle at a Horizontal and Vertical Angle (TN-Mode), or at an Azimuth Angle of 45° (IPS-Mode)

Using a tester (EZ-Contrast 160D, by ELDIM), the liquid crystal display devices produced in the above Examples were tested its contrast viewing angle, for the brightness at the time of black level of display (L1) and at the time of white level of display (L8); and the contrast ratio represented by (brightness at the time of white level of display/brightness at the time of black level of display) were determined through computation at an azimuth angle of 80°, at a polar angle of 80° (each in TN-mode), and at both of an azimuth angle and a polar angle of 45° (IPS-mode), the mean value of the contrast value was determined. The tested samples were evaluated on the basis of the criteria mentioned below.

OO: at least 50.
O: from 40 to less than 50.
Δ: from 30 to less than 40.
x: less than 30.

### (4) Humidity Dependency of the Display

The liquid crystal display devices produced in the above were preserved for 10 days under the condition of 25° C. and relative humidity 10%, tested, for the brightness at the time of black level of display (L1) and at the time of white level of display (L8); and the contrast ratio represented by (brightness at the time of white level of display/brightness at the time of black level of display) were determined through computation at an azimuth angle of 80°, at a polar angle of 80° (each in TN-mode), and at both of an azimuth angle and a polar angle of 45° (IPS-mode), the mean value of the contrast value was determined. The tested samples were evaluated on the basis of the criteria mentioned below.

OO: at least 30.
O: from 20 to less than 30.
x: less than 20.

TABLE 2

| | Dope | | | | | | | | | | | |
|---|---|---|---|---|---|---|---|---|---|---|---|---|
| | | | Plasticizar | | | | | | | | | |
| | | | Plasticizar not having a | | | Plastitizar having a | | | | | | |
| | | | Negative Birefringence | | | Negative Birefringence | | | | | | |
| | Cellulose Acylate | | | Number | | | Weight | | Retardation | | Wave-length Dispersion | |
| | Substituted | Substituted | | Average | | | Average | | Controlling Agent | | Controlling Agent | |
| | Degree of | Degree of | | Molecular | Amount | | Molecular | Amount | | Amount | | Amount |
| | Acetyl | Propionyl | Kinds | weight | [wt %] | Kinds | Weight | [wt %] | Kinds | [wt %] | Kinds | [wt %] |
| Ex. 1 | 2.94 | 0 | AA-1 | 1000 | 15 | — | — | — | BB-1 | 1.0 | — | — |
| Ex. 2 | 2.94 | 0 | AA-1 | 1000 | 10 | — | — | — | BB-1 | 1.3 | — | — |
| Ex. 3 | 2.94 | 0 | AA-1 | 1000 | 10 | — | — | — | BB-1 | 0.8 | — | — |
| Ex. 4 | 2.94 | 0 | AA-1 | 1000 | 20 | — | — | — | BB-1 | 1.5 | — | — |
| Ex. 5 | 2.94 | 0 | AA-1 | 1000 | 30 | — | — | — | BB-1 | 1.5 | — | — |
| Ex. 6 | 2.94 | 0 | AA-1 | 1000 | 10 | — | — | — | BB-1 | 1.5 | — | — |
| Ex. 7 | 2.94 | 0 | AA-1 | 1000 | 10 | — | — | — | BB-1 | 1.5 | — | — |
| Ex. 8 | 2.94 | 0 | AA-1 | 1000 | 10 | — | — | — | BB-1 | 1.5 | — | — |
| Ex. 9 | 2.94 | 0 | AA-1 | 1000 | 10 | — | — | — | BB-2 | 1.5 | — | — |
| Ex. 10 | 2.94 | 0 | AA-1 | 1000 | 10 | — | — | — | BB-2 | 1.5 | — | — |
| Ex. 11 | 2.94 | 0 | AA-2 | 1000 | 12 | — | — | — | BB-1 | 1.5 | — | — |
| Ex. 12 | 2.94 | 0 | AA-3 | 5000 | 10 | — | — | — | BB-1 | 1.5 | — | — |
| Ex. 13 | 2.94 | 0 | AA-4 | 10000 | 10 | — | — | — | BB-1 | 1.5 | — | — |
| Ex. 14 | 2.94 | 0 | AA-5 | 247 | 12 | — | — | — | — | — | AB-1 | 7.5 |
| Ex. 15 | 2.94 | 0 | AA-2 | 1000 | 12 | — | — | — | — | — | AB-2 | 2 |
| Ex. 16 | 2.94 | 0 | AA-2 | 1000 | 12 | — | — | — | — | — | AB-3 | 5 |
| Ex. 17 | 2.7 | 0 | AA-1 | 1000 | 10 | — | — | — | BB-1 | 1.0 | — | — |
| Ex. 18 | 2.86 | 0 | AA-1 | 1000 | 10 | — | — | — | BB-1 | 1.0 | — | — |
| Ex. 19 | 2.94 | 0 | AA-1 | 1000 | 10 | — | — | — | BB-1 | 1.5 | — | — |
| Ex. 20 | 2.4 | 0.6 | AA-1 | 1000 | 10 | — | — | — | BB-1 | 1.5 | — | — |
| Ex. 21 | 1.7 | 1 | AA-1 | 1000 | 10 | — | — | — | BB-1 | 1.5 | — | — |
| Ex. 22 | 2.86 | 0 | AA-1 | 1000 | 10 | AF-1 | 5500 | 10 | BB-1 | 2.0 | — | — |
| Ex. 23 | 2.94 | 0 | AA-1 | 1000 | 10 | AF-2 | 2000 | 10 | BB-1 | 2.5 | — | — |
| Ex. 24 | 2.94 | 0 | AA-1 | 1000 | 10 | — | — | — | BB-1 | 1.5 | — | — |
| Comp. Ex. 1 | 2.94 | 0 | AA-1 | 1000 | 10 | — | — | — | BB-1 | 1.5 | — | — |
| Comp. Ex. 2 | 2.94 | 0 | AA-1 | 1000 | 10 | — | — | — | BB-1 | 1.5 | — | — |
| Comp. Ex. 3 | 2.94 | 0 | AA-5 | 247 | 12 | — | — | — | — | — | AB-1 | 7.5 |
| Comp. Ex. 4 | 2.94 | 0 | AA-1 | 1000 | 15 | — | — | — | BB-1 | 1.0 | — | — |
| Comp. Ex. 5 | 2.94 | 0 | AA-1 | 1000 | 15 | — | — | — | BB-1 | 1.0 | — | — |
| Ex. 25 | 2.94 | 0 | AA-1 | 1000 | 10 | — | — | — | BB-1 | 0.8 | — | — |
| Ex. 26 | 2.94 | 0 | AA-1 | 1000 | 15 | — | — | — | BB-1 | 1.0 | — | — |
| Ex. 27 | 2.94 | 0 | AA-1 | 1000 | 15 | — | — | — | BB-1 | 1.0 | — | — |
| Ex. 28 | 2.94 | 0 | AA-1 | 1000 | 15 | — | — | — | BB-1 | 0.8 | — | — |

| | Process | | | | | | | | |
|---|---|---|---|---|---|---|---|---|---|
| | First Stretching Process (MD) | | | Drying Process | | | Second Stretching Process (TD) | | |
| | | Amount of | | | Amount of | Amount of | | Amount of | |
| | | Residual | | | Residual | Residual | | Residual | |
| | | Solvent at the | Drawing | | Solvent at the | Solvent at the | | Solvent at the | Drawing |
| | Temp. | bigining | Ratio | Temp. | bigining | termination | Temp. | bigining | Ratio |
| | [° C.] | [wt %] | [%] | [° C.] | [wt %] | [wt %] | [° C.] | [wt %] | [%] |
| Ex. 1 | −5 | 270 | 40 | 80 | 40 | 7 | 135 | 7 | 4 |
| Ex. 2 | −7 | 300 | 35 | 80 | 40 | 5 | 120 | 5 | 5 |
| Ex. 3 | −7 | 300 | 30 | 80 | 40 | 10 | 110 | 10 | 5 |
| Ex. 4 | −7 | 300 | 30 | 80 | 40 | 5 | 100 | 5 | 5 |
| Ex. 5 | −7 | 300 | 30 | 80 | 40 | 3 | 90 | 3 | 2 |
| Ex. 6 | −7 | 270 | 30 | 80 | 40 | 4 | 140 | 4 | 1 |
| Ex. 7 | −7 | 270 | 30 | 80 | 40 | 6 | 120 | 6 | 5 |
| Ex. 8 | −7 | 270 | 30 | 80 | 40 | 3 | 120 | 3 | 5 |
| Ex. 9 | −7 | 270 | 30 | 80 | 40 | 4 | 135 | 4 | 5 |
| Ex. 10 | −7 | 270 | 25 | 60 | 60 | 5 | 135 | 5 | 5 |
| Ex. 11 | −7 | 270 | 30 | 80 | 30 | 2 | 135 | 2 | 5 |
| Ex. 12 | −7 | 270 | 20 | 80 | 30 | 3 | 135 | 3 | 5 |
| Ex. 13 | −7 | 270 | 30 | 80 | 30 | 5 | 135 | 5 | 5 |
| Ex. 14 | −7 | 270 | 40 | 80 | 30 | 5 | 135 | 5 | 1 |
| Ex. 15 | −7 | 270 | 45 | 80 | 30 | 5 | 135 | 5 | 1 |
| Ex. 16 | −7 | 270 | 50 | 80 | 30 | 5 | 135 | 5 | 1 |
| Ex. 17 | −7 | 270 | 80 | 150 | 30 | 5 | 140 | 5 | 25 |
| Ex. 18 | −7 | 270 | 50 | 100 | 80 | 6 | 135 | 6 | 5 |
| Ex. 19 | −5 | 270 | 70 | 80 | 40 | 2 | 135 | 2 | 1 |
| Ex. 20 | −7 | 150 | 10 | 50 | 100 | 5 | 135 | 5 | 5 |
| Ex. 21 | −7 | 200 | 100 | 60 | 10 | 2 | 90 | 2 | 3 |
| Ex. 22 | −5 | 270 | 30 | 80 | 40 | 7 | 120 | 7 | 3 |
| Ex. 23 | −5 | 270 | 30 | 80 | 40 | 5 | 135 | 5 | 4 |
| Ex. 24 | −5 | 270 | 40 | 70 | 8 | 3 | 135 | 3 | 4 |
| Comp. Ex. 1 | −5 | 270 | 40 | 80 | 155 | 10 | 135 | 10 | 4 |
| Comp. Ex. 2 | −5 | 270 | 40 | 200 | 0 | — | — | — | — |
| Comp. Ex. 3 | 160 | 0 | 30 | 200 | 0 | — | — | — | — |
| Comp. Ex. 4 | −5 | 270 | 40 | 80 | 40 | 15 | 135 | 15 | 4 |
| Comp. Ex. 5 | −5 | 270 | 40 | 80 | 5 | 1 | 135 | 1 | 4 |
| Ex. 25 | −5 | 270 | 70 | 120 | 40 | 5 | 120 | 5 | 25 |
| Ex. 26 | −5 | 270 | 40 | 120 | 30 | 7 | 120 | 7 | 10 |
| Ex. 27 | −5 | 270 | 40 | 120 | 30 | 7 | 110 | 7 | 15 |
| Ex. 28 | −5 | 270 | 45 | 120 | 30 | 7 | 120 | 7 | 20 |

TABLE 3

| | Property of Cellulose Acylate Film | | | | | | | |
|---|---|---|---|---|---|---|---|---|
| | | | | Re(450)- | Rth(450)- | | Optically-Anisotropic Layer | |
| | | | | Re(550) | Rth(550) | | Formulation of | |
| | Re [nm] | Rth [nm] | Nz | [nm] | [nm] | ΔHc (J/g) | Coating Liquid | Re [nm] |
| Ex. 1 | 80 | 60 | 1.3 | 8 | −20 | 0.2 | 1 | 28 |
| Ex. 2 | 75 | 55 | 1.2 | 7.5 | −18 | 0.2 | 2 | 28 |
| Ex. 3 | 85 | 60 | 1.2 | 8.5 | −20 | 0.2 | 3 | 26 |
| Ex. 4 | 80 | 65 | 1.3 | 8 | −16 | 0.2 | 4 | 30 |
| Ex. 5 | 75 | 70 | 1.4 | 7.5 | −22 | 0.2 | 5 | 28 |
| Ex. 6 | 80 | 65 | 1.3 | 8 | −20 | 0.2 | 6 | 27 |
| Ex. 7 | 85 | 60 | 1.2 | 8.5 | −25 | 0.2 | 7 | 29 |
| Ex. 8 | 80 | 60 | 1.3 | 8 | −20 | 0.2 | 8 | 28 |
| Ex. 9 | 80 | 60 | 1.3 | 8 | −23 | 0.2 | 1 | 27 |
| Ex. 10 | 90 | 65 | 1.2 | 9 | −20 | 0.1 | 1 | 27 |
| Ex. 11 | 80 | 60 | 1.3 | 8 | −20 | 0.1 | 1 | 27 |
| Ex. 12 | 60 | 60 | 1.5 | 6 | −24 | 0.1 | 1 | 27 |
| Ex. 13 | 80 | 65 | 1.3 | 8 | −20 | 0.1 | 1 | 27 |
| Ex. 14 | 90 | 60 | 1.2 | −20 | 30 | 0.1 | 1 | 27 |
| Ex. 15 | 75 | 70 | 1.4 | −4 | 18 | 0.1 | 1 | 27 |
| Ex. 16 | 75 | 75 | 1.5 | 2 | −4 | 0.1 | 1 | 27 |
| Ex. 17 | 60 | 20 | 0.8 | 2 | −15 | 0.1 | 1 | 27 |
| Ex. 18 | 80 | 50 | 1.1 | 8 | −12 | 0.1 | 1 | 27 |
| Ex. 19 | 150 | 0 | 0.5 | 16 | −15 | 0.2 | — | — |
| Ex. 20 | 150 | −5 | 0.5 | 4 | −25 | 0.3 | — | — |
| Ex. 21 | 270 | −10 | 0.5 | 27 | −23 | 0.2 | — | — |
| Ex. 22 | 90 | 50 | 1.1 | 9 | −20 | 0.2 | 1 | 28 |
| Ex. 23 | 80 | 60 | 1.3 | 8 | −20 | 0.2 | 1 | 28 |
| Ex. 24 | 35 | 30 | 1.4 | 5 | −20 | 2.7 | 1 | 27 |
| Comp. Ex. 1 | Could not be evaluated because solvent was foamed and film was whitened. | | | | | | — | — |
| Comp. Ex. 2 | 80 | 60 | 1.3 | 8 | −20 | 2.7 | 1 | 27 |
| Comp. Ex. 3 | 90 | 60 | 1.2 | −20 | 30 | 0 | 1 | 27 |
| Comp. Ex. 4 | 40 | 60 | 2 | 4 | −20 | 0.2 | 1 | 28 |
| Comp. Ex. 5 | 15 | 40 | 3.2 | −5 | −20 | 2 | 1 | 28 |
| Ex. 25 | 150 | 0 | 0.5 | 16 | −15 | 0.4 | — | — |
| Ex. 26 | 70 | 50 | 1.2 | 8 | −20 | 0.5 | 1 | 28 |
| Ex. 27 | 70 | 50 | 1.2 | 8 | −20 | 0.7 | 1 | 28 |
| Ex. 28 | 70 | 45 | 1.1 | 8 | −20 | 1.0 | 1 | 28 |

| | Evaluation | | | | | |
|---|---|---|---|---|---|---|
| | | | Angle between Slow Axis | Evaluation for Display | | Humidity |
| | Film | | of the Film and MD | Liquid-Crystal | Viewing | Dependency |
| | Discharge | Volatilization | (°) | Cell | Angle | of Display |
| Ex. 1 | Nothing | Nothing | 90 | TN | ∘ | ∘∘ |
| Ex. 2 | Nothing | Nothing | 90 | TN | ∘ | ∘∘ |
| Ex. 3 | Nothing | Nothing | 90 | TN | ∘ | ∘∘ |
| Ex. 4 | Nothing | Nothing | 90 | TN | ∘ | ∘∘ |
| Ex. 5 | Nothing | Nothing | 90 | TN | ∘ | ∘∘ |
| Ex. 6 | Nothing | Nothing | 90 | TN | ∘ | ∘∘ |
| Ex. 7 | Nothing | Nothing | 90 | TN | ∘ | ∘∘ |
| Ex. 8 | Nothing | Nothing | 90 | TN | ∘ | ∘∘ |
| Ex. 9 | Nothing | Nothing | 90 | TN | ∘ | ∘∘ |
| Ex. 10 | Nothing | Nothing | 90 | TN | ∘ | ∘∘ |
| Ex. 11 | Nothing | Nothing | 90 | TN | ∘ | ∘∘ |
| Ex. 12 | Nothing | Nothing | 90 | TN | ∘ | ∘∘ |
| Ex. 13 | Nothing | Nothing | 90 | TN | ∘ | ∘∘ |
| Ex. 14 | Nothing | Nothing | 90 | TN | ∘∘ | ∘∘ |
| Ex. 15 | Nothing | Nothing | 90 | TN | ∘∘ | ∘∘ |
| Ex. 16 | Nothing | Nothing | 90 | TN | ∘∘ | ∘∘ |
| Ex. 17 | Nothing | Nothing | 90 | TN | ∘ | ∘∘ |
| Ex. 18 | Nothing | Nothing | 90 | TN | ∘ | ∘∘ |
| Ex. 19 | Nothing | Nothing | 90 | IPS | ∘∘ | ∘∘ |
| Ex. 20 | Nothing | Nothing | 90 | IPS | ∘∘ | ∘∘ |
| Ex. 21 | Nothing | Nothing | 90 | IPS | ∘∘ | ∘ |
| Ex. 22 | Nothing | Nothing | 90 | TN | ∘ | ∘∘ |
| Ex. 23 | Nothing | Nothing | 90 | TN | ∘ | ∘∘ |
| Ex. 24 | Nothing | Nothing | 90 | TN | x | ∘ |
| Comp. Ex. 1 | Could not be evaluated because solvent was foamed and film was whitened. | | | | | |
| Comp. Ex. 2 | Detected | Nothing | 90 | TN | ∘ | x |
| Comp. Ex. 3 | Nothing | Detected | 90 | TN | ∘∘ | x |
| Comp. Ex. 4 | Nothing | Nothing | 90 | TN | Δ | ∘ |
| Comp. Ex. 5 | Nothing | Nothing | 90 | TN | x | ∘ |
| Ex. 25 | Nothing | Nothing | 90 | IPS | ∘∘ | ∘∘ |
| Ex. 26 | Nothing | Nothing | 90 | TN | ∘ | ∘∘ |
| Ex. 27 | Nothing | Nothing | 90 | TN | ∘ | ∘∘ |
| Ex. 28 | Nothing | Nothing | 90 | TN | ∘ | ∘∘ |

From the above Table 2 and Table 3, it is known that the cellulose acylate films produced according to the production method of the invention have Nz of from 0 to 1.5 and are free from additive bleeding and evaporation. Further, it is known that the liquid crystal display devices comprising the cellulose acylate film produced according to the production method of the invention all have a good viewing angle characteristic except Example 24, and the devices in all Examples are good as the humidity dependence of display is low.

While the present invention has been described in detail and with reference to specific embodiments thereof, it will be apparent to one skilled in the art that various changes and modifications can be made therein without departing from the scope thereof.

The present disclosure relates to the subject matter contained in Japanese Patent Application No. 2009-085568, filed on Mar. 31, 2009, and Japanese Patent Application No. 2010-009860, filed on Jan. 20, 2010, the contents of which are herein incorporated by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A method for producing a cellulose acylate film, comprising in the following order:
casting a polymer solution that comprises a plasticizer having a number-average molecular weight of from 200 to 10000 and a cellulose acylate to form a web,
stretching the web having a residual solvent amount of from 100 to 300% by mass in one direction at from −30° C. to 30° C., drying the stretched web to reduce the residual solvent amount from 6 to 120% by mass to less than 12% by mass while controlling the surface temperature of the web so as not to reach 200° C. or higher, and
stretching the resulting film at from 60° C. to 200° C. in a direction different form the stretching direction of the first stretching.

2. The method for producing a cellulose acylate film according to claim 1, wherein the residual solvent amount is reduced by the drying from 8 to 100% by mass to from 2 to 10% by mass.

3. The method for producing a cellulose acylate film according to claim 1, wherein the web is stretched in the machine direction of the first stretching.

4. The method for producing a cellulose acylate film according to claim 1, wherein the surface temperature of the web is controlled to be in the range of from 50 to 120° C. during the drying.

5. The method for producing a cellulose acylate film according to claim 1, wherein the degree of acyl substitution of the cellulose acylate film is from 2.7 to 3.0.

6. The method for producing a cellulose acylate film according to claim 1, wherein the acyl group in the cellulose acylate is an acetyl group.

7. The method for producing a cellulose acylate film according to claim 1, wherein the polymer solution comprises a plasticizer having a negative intrinsic birefringence.

8. The method for producing a cellulose acylate film according to claim 7, wherein the plasticizer having a negative intrinsic birefringence has a weight-average molecular weight of from 1000 to 10000.

9. The method for producing a cellulose acylate film according to claim 1, wherein the polymer solution comprises a plasticizer having a number-average molecular weight of from 500 to 10000 and having a recurring unit.

10. The method for producing a cellulose acylate film accordig to claim 1, wherein the polymer solution comprises a polyester-type plasticizer.

11. The method for producing a cellulose acylate film according to claim 1, wherein the polymer solution comprises the plasticizer in an amount of from 2 to 30% by mass of the cellulose acylate therein.

12. A cellulose acylate film produced by:
casting a polymer solution that comprises a plasticizer having a number-average molecular weight of from 200 to 10000 and a cellulose acylate to form a web,
stretching the web having a residual solvent amount of from 100 to 300% by mass in one direction at from −30° C. to 30° C.,
drying the stretched web to reduce the residual solvent amount from 6 to 120% by mass to less than 12% by mass while controlling the surface temperature of the web so as not to reach 200° C. or higher, and
stretching the resulting film at from 60° C. to 200° C. in a direction different form the stretching direction of the first stretching.

13. The cellulose acylate film according to claim 12, of which the heat of crystallization ΔHc is from 0 to 1.0 J/g.

14. The cellulose acylate film according to claim 12, of which the in-plane retardation (Re) is from 60 nm to 300 nm.

15. The cellulose acylate film of according to claim 12, of which the direction of the slow axis is perpendicular to the machine direction in the stretching.

16. The cellulose acylate film according to claim 12, of which the thickness-direction retardation (Rth) is from −10 nm to 80 nm.

17. A retardation film comprising a laminate of an optically anisotropic layer of a liquid crystal composition and a cellulose acylate film, wherein the cellulose acylate film is produced by:
casting a polymer solution that comprises a plasticizer having a number-average molecular weight of from 200 to 10000 and a cellulose acylate to form a web,
stretching the web having a residual solvent amount of from 100 to 300% by mass in one direction at from −30° C. to 30° C.,
drying the stretched web to reduce the residual solvent amount from 6 to 120% by mass to less than 12% by mass while controlling the surface temperature of the web so as not to reach 200° C. or higher, and
stretching the resulting film at from 60° C. to 200° C. in a direction different form the stretching direction of the first stretching.

18. A polarizer comprising a cellulose acylate film produced by:
casting a polymer solution that comprises a plasticizer having a number-average molecular weight of from 200 to 10000 and a cellulose acylate to form a web,
stretching the web having a residual solvent amount of from 100 to 300% by mass in one direction at from −30° C. to 30° C.,
drying the stretched web to reduce the residual solvent amount from 6 to 120% by mass to less than 12% by mass while controlling the surface temperature of the web so as not to reach 200° C. or higher, and
stretching the resulting film at from 60° C. to 200° C. in a direction different form the stretching direction of the first stretching.

19. An image display device comprising a polarizer, wherein the polarizer comprises a cellulose acylate film produced by:
casting a polymer solution that comprises a plasticizer having a number-average molecular weight of from 200 to 10000 and a cellulose acylate to form a web,
stretching the web having a residual solvent amount of from 100 to 300% by mass in one direction at from −30° C. to 30° C.,
drying the stretched web to reduce the residual solvent amount from 6 to 120% by mass to less than 12% by mass while controlling the surface temperature of the web so as not to reach 200° C. or higher, and
stretching the resulting film at from 60° C. to 200° C. in a direction different form the stretching direction of the first stretching.

20. The image display device according to claim 19 having a liquid crystal cell, of which the display mode is in-plane switching or twisted nematic mode.
